(19) United States
(12) Patent Application Publication
(10) Pub. No.: US 2023/0295008 A1
(43) Pub. Date: Sep. 21, 2023

(54) FILTER ASSEMBLIES AND METHODS OF FILTERING WITH THE SAME

(71) Applicant: Brita LP, Oakland, CA (US)

(72) Inventors: Elizabeth BRANSFORD, Pleasanton, CA (US); David ZHONG, Pleasanton, CA (US); Russell E. BELL, Pleasanton, CA (US); Jonathan MCDONALD, Pleasanton, CA (US)

(21) Appl. No.: 18/185,019

(22) Filed: Mar. 16, 2023

Related U.S. Application Data
(60) Provisional application No. 63/320,960, filed on Mar. 17, 2022.
(60) Provisional application No. 63/333,350, filed on Apr. 21, 2022.

(51) Int. Cl. C02F 1/00

(52) U.S. Cl. CPC C02F 1/003; C02F 2307/04

(57) ABSTRACT

A filter assembly or fluid filter includes a housing and a filter media insert. The filter media insert may be located in a cavity of the housing. The filter may include closure or cap that can be coupled to the housing to close the cavity. The closure and the housing may collectively form a substantially closed volume within which the filter media insert can be removably secured.

### RELATED APPLICATIONS

This application claims priority to U.S. Patent Application Ser. No. 63/320,960, filed Mar. 17, 2022, entitled “Filter Assemblies and Method of Filtering with the Same”, and to U.S. Patent Application Ser. No. 63/333,350, filed Apr. 21, 2022, entitled “Filter Assemblies and Method of Filtering with the Same,” the disclosures of each of which are incorporated by reference herein in its entirety.

### TECHNICAL FIELD

The present disclosure relates to filter assemblies for fluid or water filtration apparatuses and, more specifically, to multi-part filter assemblies that are environmentally friendly, efficient in filtering volumes of fluid or water, and effective in contaminant reduction.

### BACKGROUND

A fluid or water filtration apparatuses often include a removable and replaceable filter assembly. For example, some water filtration pitchers or countertop containers are configured to position a filter assembly between a first reservoir and a second reservoir. Water is filtered as it passes from the first reservoir to the second reservoir through a filter assembly. Alternatively, a pitcher or countertop container may filter water as water is poured or dispensed therefrom. As another example, water filtration apparatuses may be configured to attach to a faucet or another such water source and may position a filter assembly to filter as water is dispensed from the faucet or water source.

Regardless of the form factor of a water filtration apparatus, a removable filter installed in these water filtration apparatuses must be replaced over time. Often, a used filter is discarded in its entirety. More specifically, many filter assemblies include granules of filter media contained within a large plastic housing and some type of porous substrate or barrier to contain the granules while allowing water to pass through the assembly. The granules and porous barrier can act to reduce contaminants, but both lose effectiveness over the life of the filter. When the granules or the porous barrier loses effectiveness, users typically discard an entire filter, including the plastic housing, porous materials, and the granules. In some instances, this can occur as often as every few weeks.

### SUMMARY

Techniques for filtering a fluid, such as water, with a multi-part filter assembly are disclosed. These techniques may be embodied as one or more apparatuses, one or more methods, and/or one or more systems. For example, in accordance with at least one embodiment, the present application is directed to a filter assembly including a filter housing and a filter media insert. The filter media insert may be secured within (i.e., encapsulated in) a filter housing and/or removably coupled to a filter housing. When the filter media insert is secured within a filter housing, the filter housing may include a barrel and a closure. The closure may removably seal against the barrel to form a substantially closed volume within which the filter media insert can be removably secured.

In one embodiment, the filter housing is tapered and the filter media insert includes an insertion end with tapered edges. The tapered edges of the filter media insert may have a profile that substantially matches a taper profile of the filter housing. Among other advantages, matching the taper of the filter media insert with the taper of the filter housing may encourage the filter media insert to seal against the filter housing. This may prevent, or at least discourage, water from bypassing the filter media insert while moving through the filter assembly. Additionally or alternatively, a bottom of the filter housing may include one or more orifices that are each at least partially surrounded by an orifice guard or spacing structure, such as a post. The orifice guard prevents the filter media insert from resting directly against the one or more orifices. This structure may prevent the filter media insert from clogging or obstructing the one or more orifices, which may be critical because, in at least some embodiments, the orifice may at least partially control a flow rate of water through the filter assembly. These and other advantages and features will become evident in view of the drawings and detailed description.

In one embodiment of the present invention, a fluid filter that can be located in a dispensing apparatus that has a first region in which an unfiltered fluid is located and a second region in which a filtered fluid is collected, the fluid filter comprising a housing located to receive the unfiltered fluid from the first region, the housing including a wall having an inner surface and a bottom surface that collectively define a cavity, an inlet opening through which unfiltered fluid passes into the cavity, and an outlet opening through which filter fluid passes from the cavity, the housing defining a flow path for fluid passing therethrough between the inlet opening and the outlet opening, a top removably coupled to the housing, and a drapeable container having a filter media located therein, the drapeable container being insertable into the cavity when the top is removed from the housing, wherein one of the engagement portion of the top or the bottom surface of the housing applies a force on the drapeable container, the drapeable container and the filter media extending across the flow path when the drapeable container is located in the housing, thereby ensuring that fluid passing from the inlet opening to the outlet opening engages the drapeable container and the filter media so that at least one contaminant is reduced from the fluid passing through the fluid filter.

In one embodiment, the wall of the housing extends around an inner perimeter of the cavity, and the drapeable container engages the inner surface of the wall around the inner perimeter of the cavity. In addition, the cavity has a substantially circular cross-section defined by the inner surface of the wall. Alternatively, the top has an engagement portion that applies a force on the drapeable container so that the drapeable container expands laterally to contact the inner surface of the wall. In an alternative embodiment, the engagement portion is substantially ring-shaped. In yet another alternative embodiment, the engagement portion is coupled to a biasing member that biases the engagement portion toward the drapeable container located in the housing.

In another embodiment, when the top is coupled to the housing, the top applies a force to the drapeable container so that the drapeable container engages the inner surface of the wall and the fluid traveling from the inlet opening to the outlet opening passes through the drapeable container and engages the filter media.

In another embodiment, the drapeable container has an upper portion, a bottom portion opposite the upper portion, and a side portion between the upper portion and the bottom portion, and when the drapeable container is inserted into the cavity, and the side portion of the drapeable container engages the inner surface of the wall. Alternatively, the housing includes an inner bottom surface, and when the upper portion of the drapeable container is engaged by the top, the drapeable container engages the housing inner bottom surface, and the side portion of the drapeable container engages the inner surface of the wall continuously around the cavity to seal the flow path between the inlet opening and the outlet opening.

In an alternative embodiment, the drapeable container is formed of at least one wall member made of a porous material, the at least one wall member defining a compartment in which the filter media is located, and the fluid flowing from the inlet opening to the outlet opening flows through the at least one wall member and engages the filter media in the drapeable container.

In another embodiment, the housing has an upper end and a lower end opposite the upper end, the housing wall extends from the upper end to the lower end, and the housing wall is tapered from the upper end to the lower end. In addition, the cavity defined by the inner surface of the wall has a first inner diameter proximate to the upper end and a second inner diameter proximate to the lower end, the first inner diameter being larger than the second inner diameter.

In yet another embodiment, the housing has an inner bottom surface and at least one post extending upwardly from the inner bottom surface, and the at least one post is proximate to the outlet opening and engages the drapeable container when the drapeable container is in the cavity to prevent the drapeable container from blocking the outlet opening. Alternatively, the housing includes four spaced apart posts extending upwardly from the inner bottom surface, and each of the posts engages the drapeable container when the drapeable container is in the cavity. Also, the housing has an inner bottom surface with a spacing structure extending upwardly therefrom, and the spacing structure engages the drapeable container to prevent it from blocking the outlet opening.

In another embodiment of the present invention, a fluid filter for removing a contaminant from a fluid comprises a housing including a wall and a bottom surface defining a cavity, the housing including an outlet through which fluid can pass, the outlet being in communication with the cavity, a top removably coupled to the housing, one of the housing and the top including an inlet through which fluid can pass, the inlet being in communication with the cavity, the housing defining a flow path between the inlet and the outlet, and a drapeable pouch containing a filter media therein, the drapeable pouch being disposable in the cavity, the top engaging the drapeable pouch when the top is coupled to the housing, wherein one of the top and the housing bottom surface applies a force to the drapeable pouch so that the drapeable pouch and the filter media extend across the cavity and seal the flow path so that fluid entering the inlet engages the filter media in the drapeable pouch before the fluid exits the outlet of the housing.

In an alternative embodiment, the housing wall extends around an inner perimeter of the cavity, and the drapeable pouch engages the housing wall around the inner perimeter of the cavity. Alternatively, the top includes an engagement portion coupled to a biasing member that biases the engagement portion into contact with the drapeable pouch. In another embodiment, the housing includes an inner bottom surface and a spacing structure extending upwardly from the inner bottom surface, and the spacing structure engages the drapeable pouch and prevents the drapeable pouch from blocking the outlet when the drapeable pouch is in the housing. Alternatively, the housing has an upper end and a lower end opposite the upper end, the housing wall is tapered from the upper end to the lower end, the cavity has a first inner diameter proximate to the upper end and a second inner diameter proximate to the lower end, and the first inner diameter is larger than the second inner diameter.

In another embodiment of the present invention, a fluid dispensing apparatus comprises a container defining a first area in which an unfiltered fluid to be filtered is located and a second area in which a filtered fluid is collected, the second area being spaced apart from the first area, a filter coupleable to the container at a location between the first area and the second area, the filter receiving unfiltered fluid from the first area and removing at least one contaminant therefrom, the filter comprising a housing including a wall with an inner surface that defines a cavity, an inlet in communication with the cavity, and an outlet in communication with the cavity, and a pouch being formed of a drapeable material defining a receptacle in which a filter media is located, the pouch being insertable into the housing cavity, the pouch extending across the housing cavity to ensure that fluid passing from the inlet to the outlet engages the filter media in the pouch before passing through the outlet.

In one embodiment, the pouch can be removed from the housing while the housing remains coupled to the container. Alternatively, the housing cavity has a circular cross-section, and the pouch and the filter media seal across the housing cavity cross-section. In another embodiment, the housing includes a first coupling mechanism, and the fluid dispensing apparatus further comprises a top removably coupled to the housing, the top including a second coupling mechanism engageable with the first coupling mechanism to secure the top to the housing. Alternatively, the top engages the pouch to apply a force to cause the pouch to extend laterally to continually engage the inner surface of the housing wall around a perimeter of the cavity.

In another embodiment of the present invention, a fluid dispensing apparatus comprises a container defining a first area in which an unfiltered fluid to be filtered is located and a second area in which a filtered fluid is collected, the second area being spaced apart from the first area, a filter coupleable to the container at a location between the first area and the second area, the filter receiving unfiltered fluid from the first area and removing at least one contaminant therefrom, the filter comprising a housing including a wall with an inner surface that defines a cavity, an inlet in communication with the cavity, and an outlet in communication with the cavity, and a pouch being formed of a drapeable material defining a receptacle in which a filter media is located, the filter media being hydrated prior to the pouch being inserted into the housing, and when the pouch is inserted, the pouch extends across the housing cavity to ensure that fluid passing from the inlet to the outlet engages the filter media in the pouch before passing through the outlet.

In another embodiment of the present invention, a method of assembling components in a fluid dispensing apparatus, the fluid dispensing apparatus including a container defining a first area in which an unfiltered fluid to be filtered is located and a second area in which a filtered fluid is collected, the second area being spaced apart from the first area, the method comprising inserting a filter housing into the container at a location between the first area and the second area, the filter housing including a wall with an inner surface and a bottom surface that collectively define a cavity, an inlet in communication with the cavity, and an outlet in communication with the cavity; inserting a filter media insert containing filter media into the filter housing; and coupling a cap to the filter housing, the cap including an engagement portion extending therefrom; and engaging the engagement portion of the cap with the filter media insert so that one of the engagement portion and the filter housing bottom surface applies a compressive force on the filter media insert to cause the filter media insert to form a seal with the inner surface of the filter housing wall.

### BRIEF DESCRIPTION OF THE DRAWINGS

To complete the description and in order to provide for a better understanding, a set of drawings is provided. The drawings form an integral part of the description and illustrate embodiments of the present application, which should not be interpreted as restricting the scope of the application. The drawings comprise the following figures:

FIG. 1 is a schematic diagram of an embodiment of a fluid or water filtration apparatus according to the present disclosure.

FIG. 2 is a schematic diagram of another embodiment of a fluid or water filtration apparatus according to the present disclosure.

FIG. 3 is a schematic diagram of an embodiment of a fluid or water filter according to the present disclosure.

FIG. 3A is a schematic diagram of an alternative embodiment of a cap according to the present disclosure.

FIG. 4 is a cross-sectional diagram of the fluid filter illustrated in FIG. 3.

FIG. 5 is a top perspective view of an embodiment of a fluid filter according to the present disclosure.

FIG. 6 is a top view of the fluid filter illustrated in FIG. 5.

FIG. 7 is a bottom view of the fluid filter illustrated in FIG. 5.

FIG. 8 is a side view of the fluid filter illustrated in FIG. 5.

FIG. 9 is a front view of the fluid filter illustrated in FIG. 5.

FIG. 10 is another side view of the fluid filter illustrated in FIG. 5.

FIG. 11 is a rear view of the fluid filter illustrated in FIG. 5.

FIG. 12 is an exploded front view of the fluid filter illustrated in FIG. 5 showing several components of the fluid filter.

FIG. 13 is a cross-sectional front view of the fluid filter illustrated in FIG. 5 with several components of the fluid filter assembled.

FIG. 14 is an exploded view of the fluid filter components illustrated in FIG. 13.

FIG. 15 is a bottom perspective view of an embodiment of the top or cap of the fluid filter illustrated in FIG. 5.

FIG. 16 is a bottom view of the top or cap of the fluid filter illustrated in FIG. 5.

FIG. 17 is a top perspective view of the housing of the fluid filter illustrated in FIG. 5.

FIG. 18 is a top perspective view of a portion of the housing illustrated in FIG. 17.

FIG. 19 is a front perspective view of a filter assembly formed from a filter housing and a filter media insert, according to an alternative embodiment of the present disclosure.

FIG. 20 is front view of the closure of the filter housing illustrated in FIG. 19.

FIG. 21 is a front view of the barrel of the filter housing illustrated in FIG. 19.

FIG. 22 is a front, cross-sectional view of the barrel of the filter housing illustrated in FIG. 21.

FIG. 23 is a cross-sectional view of a barrel for a filter housing that may form the filter assembly of the present application, according to another example embodiment.

FIG. 24 is a cross-sectional view of the barrel of FIG. 23, the cross-sectional view illustrating an orifice guard formed in accordance with one example embodiment.

FIG. 25 is a perspective view of alternative embodiment of an engagement member extending downwardly from the cap.

FIG. 26 is a cross-sectional view of an alternative embodiment of an orifice guard that may be included in the filter assemblies described herein.

FIG. 27 is a front view of the filter media insert shown in FIG. 20 while the filter media is in a horizontal orientation.

FIG. 28 is a front view of another example embodiment of a filter media insert that may be included in the filter assemblies presented herein, the filter media insert being illustrated in a horizontal orientation.

FIG. 29 is a side schematic view of a filter media insert.

FIG. 30 is a front view of the filter media insert while in a vertical orientation.

FIG. 31 illustrates an example filter media that may be used to form a filter media insert for the filter assemblies presented herein.

FIG. 32 is a front view of an additional embodiment of filter media inserts shown in a horizontal orientation that may be included in the filter assemblies presented herein.

FIGS. 33 and 34 are front and bottom views, respectively, of an additional embodiment of a filter media insert that may be included in the filter assemblies presented herein.

FIG. 35 is a front perspective view of a water filtration apparatus with which the filter assemblies presented herein may be used, according to example embodiments.

FIGS. 36-40 are different views of another embodiment of a filter media insert according to the present disclosure.

Like reference numerals have been used to identify like elements throughout this disclosure.

### DETAILED DESCRIPTION

The following description is not to be taken in a limiting sense, but is given solely for the purpose of describing the broad principles of the present application. Embodiments of the present application will be described by way of example, with reference to the above-mentioned drawings showing elements and results of such embodiments.

Generally, with the techniques presented herein, a filter assembly or fluid filter can be formed from or can include a filter housing and a filter media insert or pouch. In some embodiments, the filter housing includes a barrel and a closure, such as a cap or top, that is configured to removably seal against the barrel to form a substantially closed volume in which the filter media insert may be removably installed. That is, in at least some embodiments, the filter housing removably encapsulates the filter media insert. Additionally or alternatively, the filter media insert may be removably coupled to a filter housing. In any case, the filter media of the filter assembly (which is included in the filter media insert) can be replaced without replacing the entire filter assembly (e.g., when the filter media has reached the end of its usable lifespan). Instead, the filter media insert can be removed and replaced (e.g., every two months) while the filter housing remains usable over a much longer lifespan (e.g., multiple years). This drastically reduces the amount of waste produced by a “filter change.” Moreover, the specific design of the filter media insert presented herein may minimize waste, carbon footprint, and shipping costs while maximizing filtering efficiency (e.g., the rate at which water is filtered) and filtering performance (e.g., contaminant reduction performance).

In at least some embodiments that encapsulate the filter media insert within a filter housing, the filter housing is tapered and the filter media insert includes an insertion end with tapered edges (e.g., chamfered edges) that substantially match the taper of the filter housing. Among other advantages, matching the taper of the filter media insert with the taper of the filter housing may encourage the filter media insert to seal against the filter housing. The tapered bottom of the filter media insert facilitates sealing of the insert and the housing. In some other embodiments, the filter media insert does not have tapered edges that substantially match the profile of the filter housing. In those embodiments, the filter media insert still seals against an inner surface of a wall of the filter housing when a downward, compressive force is applied to the filter media insert. This seal prevents fluid or water from bypassing the filter media insert while the fluid or water moves through the filter assembly. Additionally or alternatively, a bottom of the filter housing may include one or more orifices that are each at least partially surrounded by an orifice guard or spacing structure that prevents the filter media insert from resting directly against the one or more orifices. By preventing the filter media insert from resting on an orifice, the filter media is prevented from clogging or obstructing the one or more orifices which may be critical because, in at least some embodiments, the orifice may at least partially control a flow rate of water through the filter assembly. This flow rate directly correlates to the filtering performance.

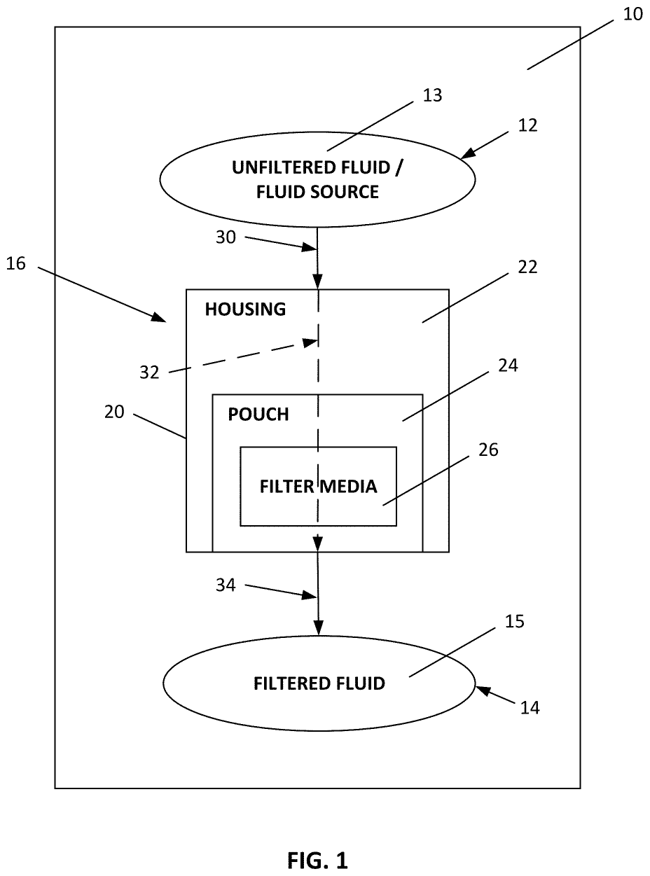

Referring to FIG. 1, a schematic diagram of an embodiment of a fluid or water filtration apparatus according to the present disclosure is illustrated. The fluid or water filtration apparatus may be referred to alternatively as a dispensing apparatus. In FIG. 1, the fluid filtration apparatus 10 includes a region 12 in which an unfiltered fluid 13 is located. The unfiltered fluid 13 can be referred to alternatively as fluid source. The region 12 can be referred to alternatively as a reservoir or area in which the filtered fluid 13 is collected and located. The region 12 can have any shape or size. The fluid filtration apparatus 10 includes another region 14 in which filtered fluid 15 is located. The filtered fluid 15 has passed through a filter that contains filter media, which removes one or more contaminants from the unfiltered fluid that passes through the filter.

In one embodiment, the fluid filtration apparatus 10 has a location 16 in which a filter 20 can be located, according to the present disclosure. The location 16 is between the unfiltered fluid 13 and the filtered fluid 15. In particular, the flow of the fluid in apparatus 10 is along path 30 from region 12 to the filter 20, along path 32 through the filter 20, and along path 34 from the filter 20 to region 14.

In this embodiment, filter 20 includes a housing 22 that defines a cavity or receptacle in which a filter media insert or pouch 24 can be inserted and placed. The filter media insert or pouch 24 includes its own receptacle in which filter media 26 can be located. In various embodiments, the filter media 26 can take various shapes and forms, and can have different structures. Some examples of filter media 26 that can be used in the filter media insert 24 are activated carbon in granular form, activated carbon felt, mixed media particles, cellulose filter media, a nonwoven filter paper, pleated filter material, filter cloths, and carbon blocks.

In the various embodiments disclosed herein, the filter media insert has a maximum width that is smaller than the width of the cavity of the housing in which the filter media insert is located. As a result, there is no creasing in the material of the filter media insert as it expands to seal against the inside of the housing, as described below.

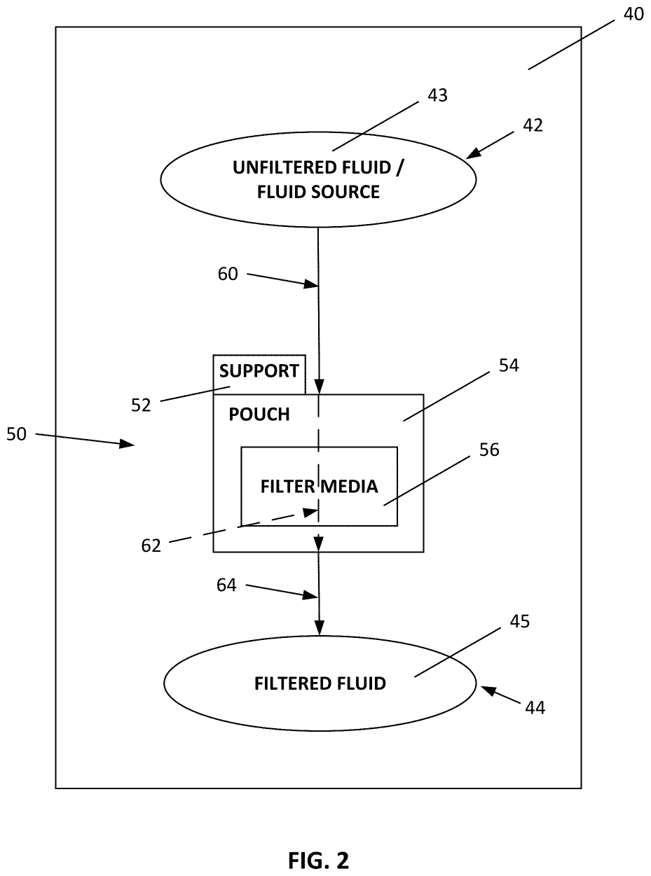

Referring to FIG. 2, a schematic diagram of another embodiment of a fluid filtration apparatus according to the present disclosure is illustrated. Fluid filtration apparatus 40 has several components similar to those of fluid filtration apparatus 10. In particular, fluid filtration apparatus 40 includes a region 42 in which an unfiltered fluid 43 is located, and another region 44 in which filtered fluid 45 is located. The flow of the fluid in apparatus 40 is along path 60 from region 42 to the filter 50 which contains filter media, along path 62 through the filter 50, and along path 64 from the filter 50 to region 44.

In this embodiment, filter 50 includes a support 52 to which a filter media insert or pouch 54 can be inserted and placed. The filter media insert or pouch 54 includes its own receptacle in which filter media 56 can be located. The support 52 is used to mount the filter media insert 54 to the apparatus 40. In one embodiment, the support 52 does not have to fully contain the filter media insert 54.

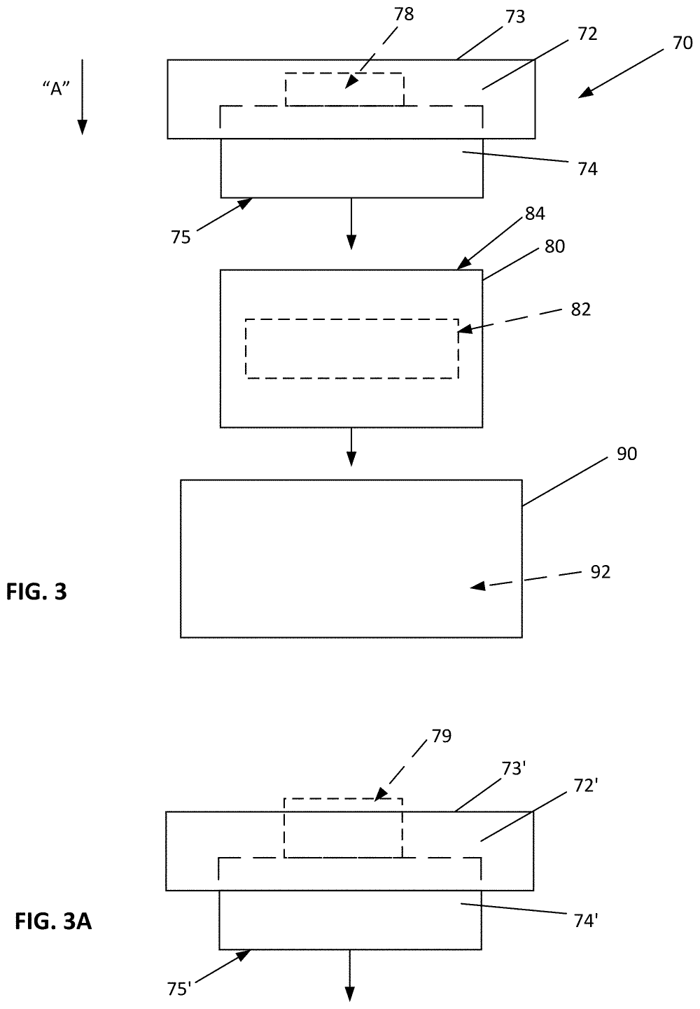

Referring to FIG. 3, a schematic diagram of an embodiment of a fluid or water filter according to the present disclosure is illustrated. As shown, fluid filter 70 includes a cap 72 that can be referred to alternatively as a top or lid. The cap 72 includes a body 73 and an engagement portion or engagement member 74 that extends downwardly from the body 73 of the cap 72. The engagement portion 74 includes an engaging surface 75, which engages a filter media insert, as described below.

In an alternative embodiment, the cap 72 may include a biasing element 78, such as a spring or other resilient member, that is coupled to the cap body 73 and to the engagement portion 74. The biasing element 78 biases the engagement portion 74 downwardly along the direction of arrow “A.” The biasing element 78 allows the engagement portion 74 to be spring-loaded to adjust for swelling of the filter media insert due to the filter media therein. In one embodiment, the biasing element 78 is a separate spring that is coupled to the engagement portion 74. In another embodiment, the biasing function is achieved by selecting a resilient material for the engagement portion 74. When the engagement portion 74 is biased downwardly, it is constantly biased into engagement with the filter media insert and can accommodate varying heights of filter media inserts for consistent and desired compression thereof.

The engagement portion 74 is used to control compression of the filter media, which impacts the fluid flow through the filter media insert. Balanced compression makes sure that the filter media insert adheres to the inner wall surface and that the flow through the filter media in the filter media insert is satisfactory. While too much compression ensures that the filter media insert is sealed to the wall, the filter media is packed together too tightly, thereby restricting the fluid flow therethrough and decreasing the fluid output of the filter to an unsatisfactory level. That also enables the use of hydrated granular fill media or dry shipping media pouches without moisture proof packaging.

Fluid filter 70 includes a housing 90 that defines a cavity 92 therein. A filter media insert 80 that forms a receptacle into which filter media 82 is placed can be inserted into the cavity 92 of the housing 90. The engagement portion 74 contacts an upper surface or end 84 of the filter media insert 80. The compressive force applied by the engagement portion 74 creates a seal of the filter media insert against the inner surface of the housing wall.

Referring to FIG. 3A, an alternative embodiment of a cap according to the present disclosure is illustrated. The cap 72′ includes a body 73′ and an engagement portion 74′ with an engaging surface or end 75′ that applies a compressive force to a filter media insert. In this this embodiment, the cap 72′ includes an adjustment mechanism 79, such as a dial, that can be manipulated by a user to change the position of the engagement portion 74′ relative to the body 73. By using the adjustment mechanism 79, the distance that the engagement portion 74′ extends downwardly from the cap body 73′ can vary. The adjustment mechanism 79 can be engaged with a ramp or threads, or frictionally engaged with an opening on the cap body 73′ to accomplish its adjustability.

In various embodiments, when the engagement portion 74 or 74′ extends downwardly farther (whether due to a biasing force on the engagement portion, a position adjustment of the engagement portion, or the engagement portion is made longer on a different cap), the filter media in the filter media insert is pressed downwardly more to slow the flow of fluid through the filter media to ensure that more contaminants are reduced from the fluid. As the force on the filter media increases in the lateral or radial direction as a result of the compressive force on the filter media insert, the fluid flow will slow down because the spaces or gaps between the filter media particles or elements are smaller.

The amount of time that the fluid, such as water, is in contact with the filter media is referred to as the fluid's residence time. The length of residence time can be influenced by changing the length of the flow path (a longer flow path for the fluid will result in an increased residence time), and also by adjusting the porosity and/or permeability of the filter media insert material and/or the filter media (by making it more difficult or alternatively easier for fluid to flow). A faster fluid flow can be achieved despite a longer flow path if the filter media is loosely packed and any compressive force on the filter media is minimal.

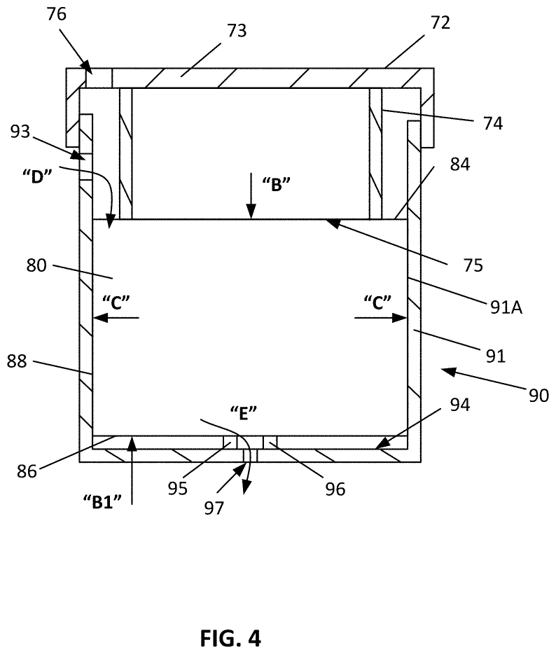

Referring to FIG. 4, a cross-sectional front view diagram of fluid filter 70 is illustrated. As shown, in this embodiment, the cap 72 includes the downwardly extending engagement portion 74 and an opening 76 formed through the cap body 73. The opening 76 allows for air to exit from the interior of the filter 70 as water enters the filter 70. In an alternative embodiment, the cap 72 does not include any opening 76 formed through the cap body 73. In that alternative embodiment, air in the interior of the filter 70 can exit through opening 93 in the housing 90, which is described below.

The engaging surface 75 of the engagement portion 74 contacts the upper surface or portion 84 of the filter media insert 80 and applies a force thereto along the direction of arrow “B.” As a result, the filter media insert 80 extends laterally along the directions of arrows “C” and into engagement with the housing 90. The housing 90 has a wall 91 that defines the receptacle or cavity 92. In one embodiment, the wall 91 has an inner surface 91A that defines the perimeter of the cavity 92. The perimeter of the cavity 92 can be referred to as an inner perimeter and it extends continuously around the inside of the cavity 92 along the inner surface 91A. In one embodiment, the cavity 92 is generally cylindrical in cross-section. In different embodiments, the wall 91 of the housing 90 can be tapered from one end to the opposite other than, or it can be substantially cylindrical with a constant inner diameter along the length of the housing 90 between the ends.

The filter media insert 80 includes a bottom portion or end 86 opposite to the upper portion or end 84. The filter media insert 80 also includes a side portion or surface 88 that extends around the filter media insert 80 and is located between the bottom portion 86 and the top portion 84. When the force along the direction of arrow “B” is applied to the filter media insert 80, the side portion 88 of the filter media insert 80 is the part of the insert 80 that moves outwardly and laterally along arrows “C” to engage with the inner surface 91A of the wall 91. In addition or alternatively, when a force along the direction of arrow “B 1” in FIG. 4 is applied to the filter media insert 80, the side portion 88 of the filter media insert 80 moves outwardly and laterally along arrows “C” to engage with the inner surface 91A of the wall 91. The force along the direction of arrow “B 1” can be applied by a bottom surface of the housing or any structure extending upwardly from the housing bottom surface that engages the bottom portion or end 86 of the filter media insert 80. Thus, a force along either or both arrow “B” and arrow “B 1” causes the filter media insert 80 to expand radially or laterally to engage the inner surface 91A of the wall 91.

In this embodiment, the housing 90 includes an inner bottom surface 94 that has one or more outlets or outlet openings 97 formed therethrough. Proximate to the outlet 97 is a spacing structure or orifice guide 95 that extends upwardly from the inner bottom surface 94. In one embodiment, the spacing structure 95 includes a post that extends upwardly. In another embodiment, the spacing structure 95 includes four spaced apart posts that extend upwardly (only posts 95 and 96 being shown in the view illustrated in FIG. 4). In yet another embodiment, the spacing structure 95 includes a 132 crown above the outlet. The spacing structure 95 engages the bottom portion 86 of the filter media insert 80 and prevents the insert 80 from resting on and blocking the outlet 97, which would prevent fluid from leaving the cavity 92 through outlet 97. The spacing structure 95 engaging the bottom portion 86 of the filter media insert 80 also results in a force being applied to the filter media insert 80 along the direction of arrow “B 1”. which results in the lateral expansion of the filter media inset 80 along the directions of arrows “C”. In other embodiments, the housing 90 may include several outlets.

In FIG. 4, an exemplary flow path of fluid traveling in fluid filter 70 is illustrated. Fluid can enter the filter 70 along the direction of arrow “D” through inlet opening 93 formed in housing wall 91. Since the filter media insert 80 has expanded laterally into engagement with inner surface 91A of housing wall 91, the filter media insert 80 and the filter media 82 seal laterally across a cross-section of the cavity 92. As a result, all of the fluid entering through inlet 93 is forced to pass through the filter media insert 80 and the filter media 82, thereby eliminating the risk of fluid bypassing the filter media 82 and contaminants not being reduced as desired. The fluid passes through the filter media insert 80 and then exits the bottom portion 86 of the insert along the direction of arrow “E” and out of the filter 70 through opening 97.

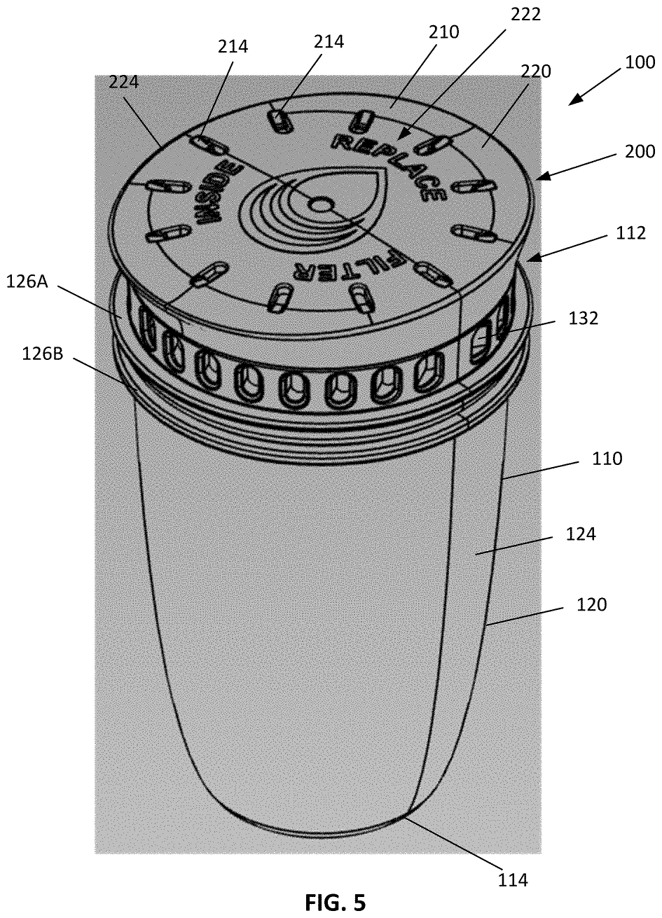

Referring to FIGS. 5-18, several components of an embodiment of a fluid filter according to the present disclosure is illustrated. Turning to FIG. 5, a top perspective view of the fluid filter 100 is illustrated. The fluid filter 100 includes a housing or body 110 and a top or cap 200 that is removably coupled to the housing 110. The housing 110 has an upper end 112 and a lower end 114 that is opposite the upper end 112. As described in more detail below, the top 200 is removably coupled to the upper end 112 of the housing 110. The housing 110 has a wall or side wall 120 that has an outer surface 124. The outer surface 124 includes a pair of ridges or flanges 126A and 126B that form a groove therebetween. The wall 120 includes several openings or vents 132 proximate to the upper end 112 through which a fluid may flow into the housing 110. The openings 132 are spaced apart around the perimeter of the wall 120. The openings 132 are located above the flanges 126A and 126B to allow more room for the filter media insert in the housing 110.

The top 200 includes a body 210 having an upper surface 220 with indicia 222 formed or printed thereon. In this embodiment, the body 210 has several openings or vents 214 formed therethrough that are located in a generally circular pattern around the upper surface 220 (only two of the openings 214 are labeled). The vents 214 allow air to pass therethrough, and due to their location on the top 200, the openings 214 do not interfere with the filter media insert. In an alternative embodiment, the body 210 does not include any openings or vents 214. In that particular embodiment, any air in the housing 110 can exit through the openings 132 in the housing 110 as water enters the housing 110 through openings 132.

In this embodiment, the top 200 has an edge 224 that defines a perimeter of the top 200. As shown in the following drawings, the edge 224 and corresponding perimeter of the top 200 have a non-constant radius, resulting in a slightly oblong or oval shape. That shape facilitates a user grasping and turning the top 200 relative to the housing 110 to decouple the top 200 from the housing 110.

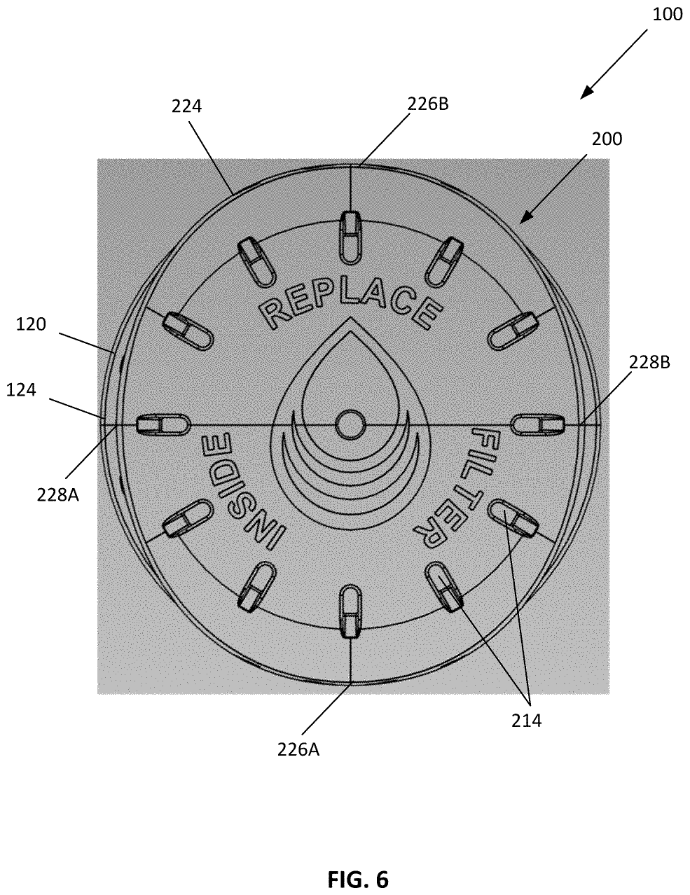

FIG. 6 is a top view of the fluid filter 100 illustrated in FIG. 5 showing the edge 224 of the top 200 and its particular shape. The distance between points 226A and 226B is greater than the distance between points 228A and 228B. As shown, the distance between points 228A and 228B is less than the outer diameter defined by the outer surface 124 of wall 120 of housing 110. To the contrary, the distance between points 226A and 226B is greater than the outer diameter defined by the outer surface 124 of wall 120, as shown in more detail below. In FIG. 6, the openings 214 through the body 210 are illustrated. In this embodiment, the top body 210 has twelve evenly spaced openings 214. These openings allow air in the fluid filter 100 to escape as a fluid enters the one or more inlet openings in the housing 110.

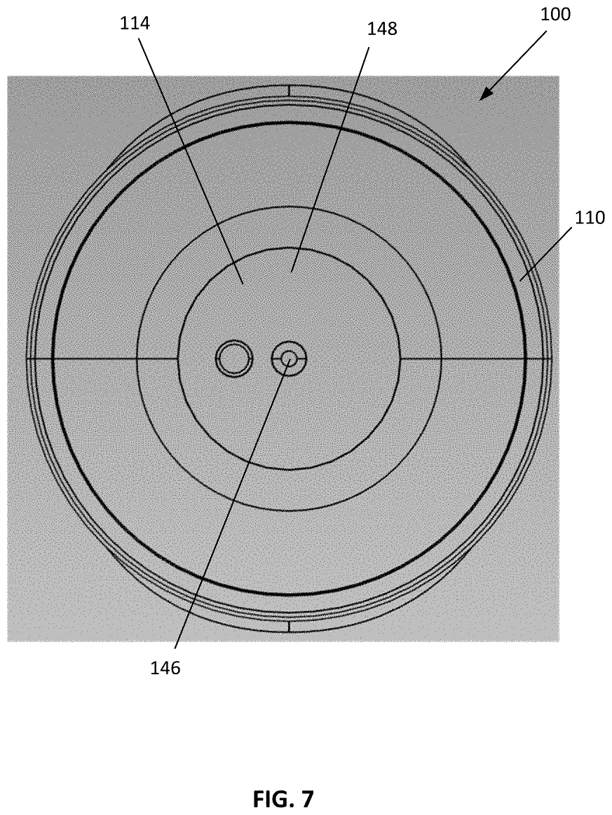

Referring to FIG. 7, a bottom view of fluid filter 100 is illustrated. As shown, the lower end 114 of the housing 110 includes an outer surface 148 of a bottom wall of the housing 110. In this embodiment, the housing 110 includes an outlet or outlet opening 146 that is in fluidic communication with the cavity of the housing 110.

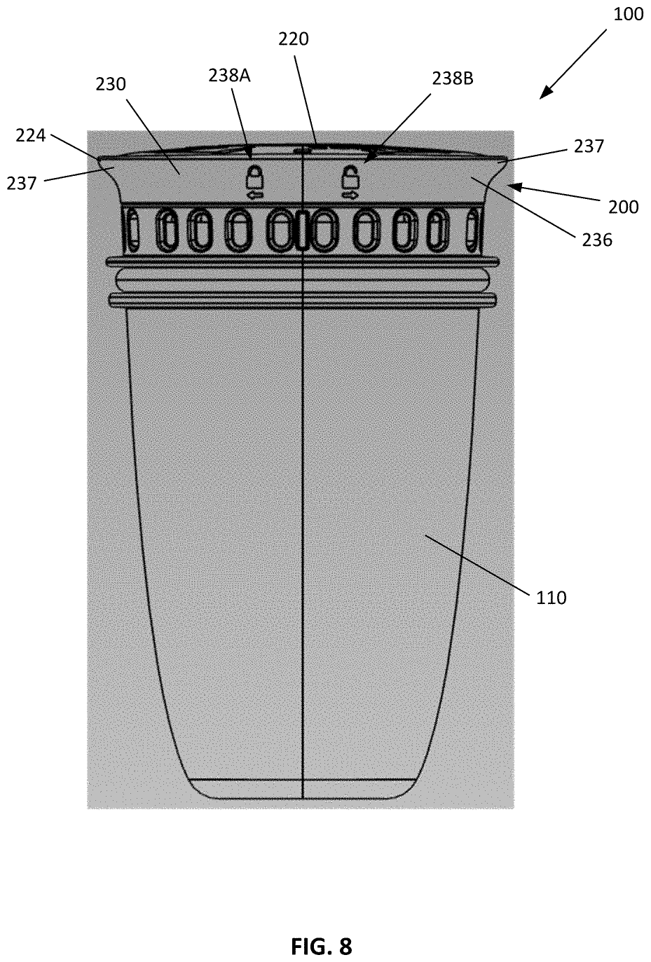

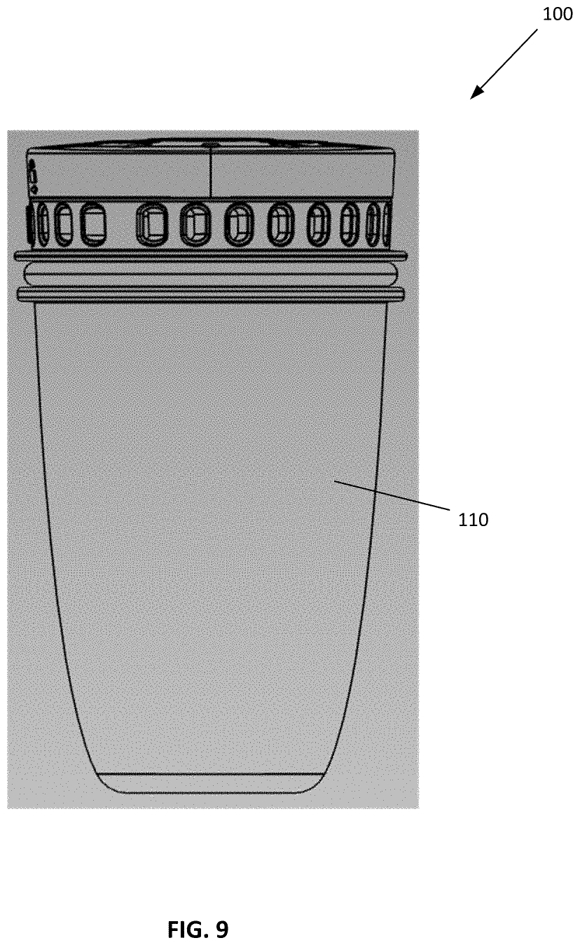

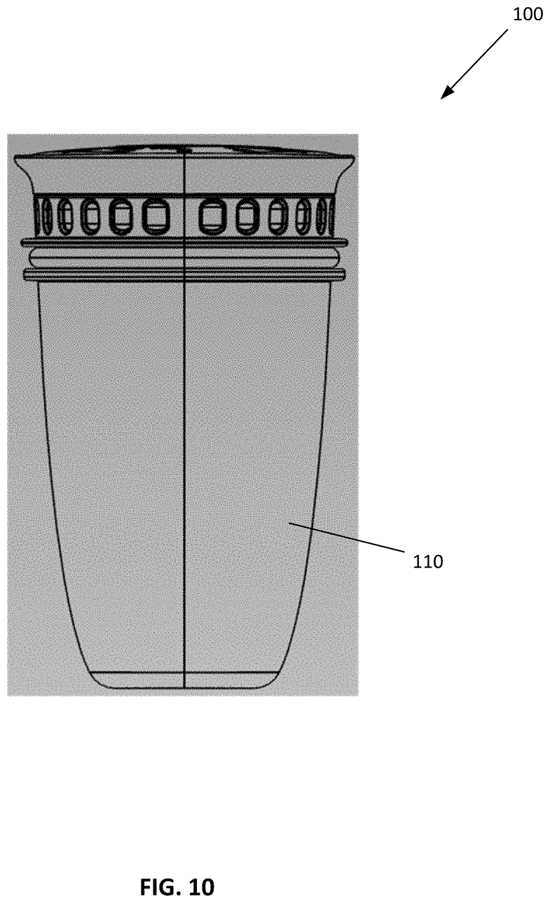

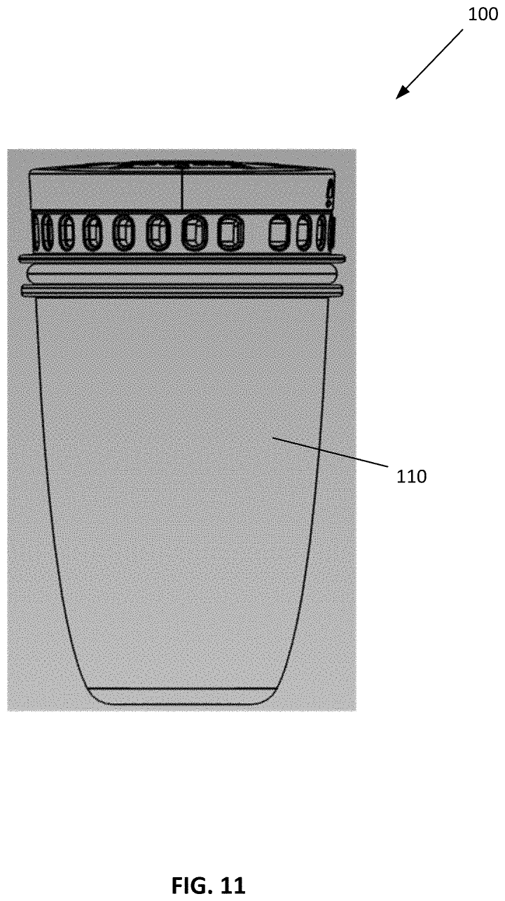

Referring to FIGS. 8-11, different elevation views of fluid filter 100 are illustrated. FIGS. 8 and 10 are opposite side views of the fluid filter 100, and FIGS. 9 and 11 are front and rear views, respectively, of the fluid filter 100. In the side views in FIGS. 8 and 10, the cap 200 includes a side portion or collar 230 that extends downwardly from the body 210. The perimeter 224 of the cap 200 extends beyond the outer diameter of the outer surface 124 of the housing wall. The extending portions of the perimeter 224 form opposing tip portions 237. The tip portions 237 provide surfaces that can be easily gripped or grasped by a user to turn or rotate the cap 200 relative to the housing 110.

In this embodiment, the collar 230 has an outer surface 236 that includes indica 238A and 238B formed thereon. Indicia 238A includes an icon of a lock and a directional arrow, which collectively designate the direction in which a user should rotate or turn the cap 200 to secure it to the housing 110. Indicia 238B includes an icon of an unlocked lock and another directional arrow, which designate the direction in which a user should rotate the cap 200 to remove it from the housing 110. Also, the cap 200 has an upper surface 220 that has a slightly raised central portion as shown in FIG. 8. In other embodiments, the cap 200 may have a flat or horizontal surface.

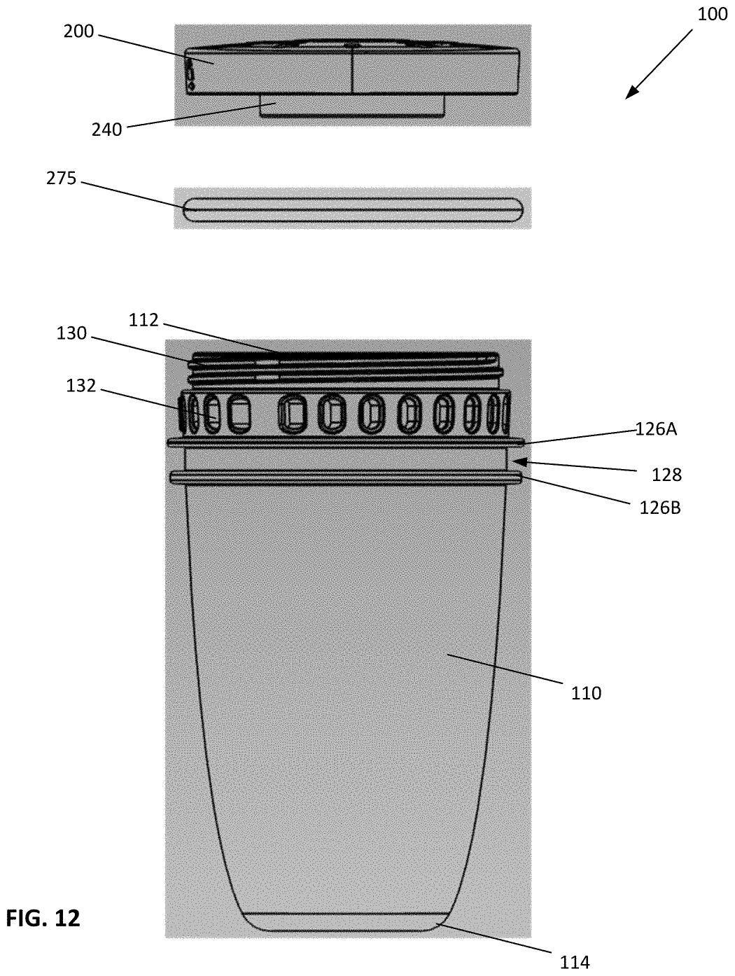

Referring to FIG. 12, an exploded front elevation view of several components of fluid filter 100 are illustrated. Several of the previously described features of the housing 110 and the cap 200 are shown in FIG. 12. The housing 110 includes opposite ends 112 and 114. Threads 130 are located proximate to upper end 112 and are used to couple the cap 200 to the housing 110. Also proximate to the upper end 112 are openings 132 through which unfiltered fluid may flow into the housing 110. Located on the outside of housing 110 are the ridges 126A and 126B that define a groove 128 therebetween. The groove 128 can receive the O-ring 275, which is used to seal the fluid filter 100 with the surrounding surface of a distribution apparatus, such as a fluid pitcher, when the housing 110 is inserted into the distribution apparatus. In this embodiment, the cap 200 includes an engagement portion 240 that extends downwardly from the cap 200. The engagement portion 240 can engage an upper end of a filter media insert (not shown in FIG. 12) when the cap 200 is coupled to the housing 110.

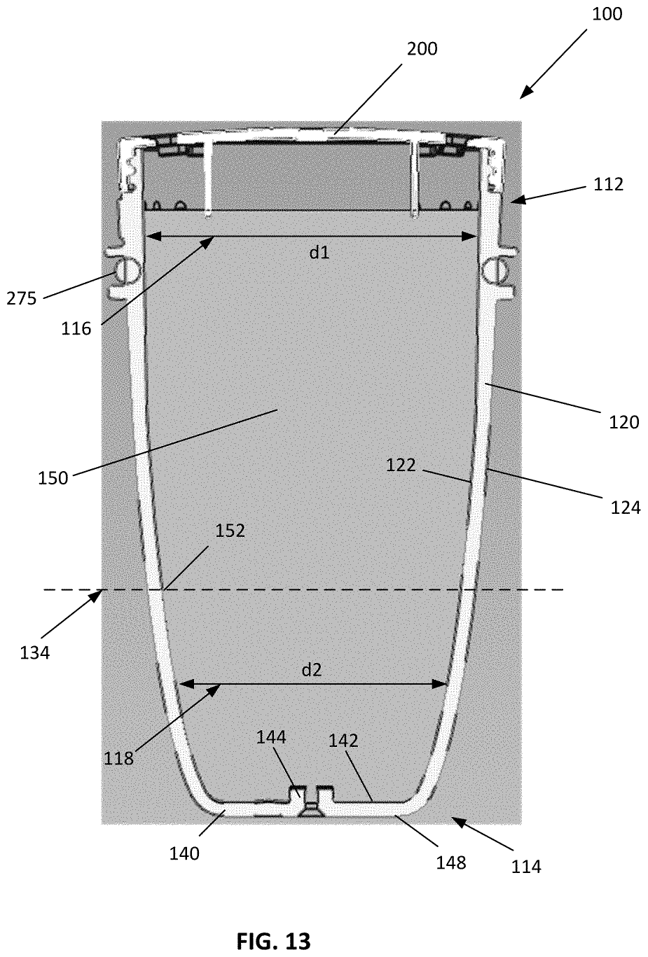

Referring to FIG. 13, a cross-sectional front elevation view of several components of the fluid filter 100 illustrated in FIG. 5 is shown. The cap 200 is coupled to the upper end 112 of the housing 110 via threads. The housing wall or side wall 120 has an inner surface 122 and an outer surface 124. The inner surface 122 defines the cavity 150 and establishes a perimeter for a cross-section taken horizontally through the housing 110. A plane 134 is shown in dotted lines as extending through the housing 110. Where the plane 134 intersects with the side wall 120 is a perimeter 152 that extends continuously around the inner surface 122. In addition, the inner diameter of the housing 110 and the cavity 150 depends on the location of the plane defining the diameter. In FIG. 13, diameter d1 is taken along the horizontal plane containing line 116, and diameter d2 is taken along the horizontal plane containing line 118. In this embodiment, diameter d1 is larger than diameter d2 due to the tapered configuration of wall 120. The tapered shape of the housing or barrel 110 helps seal the filter media insert to the inner surface of the housing wall 120. The tapered shape of the housing also aids in the assembly of the filter media insert into the housing, and the removal of the filter media insert from the housing.

At the bottom of the housing 110 is a wall or bottom wall 140 that defines the cavity 150 with side wall 120. The bottom wall 140 includes an inner surface 142 and an outer surface 148 opposite to the inner surface 142. The bottom wall 140 includes one or more posts or projections 144, also referred to as spacing structures, extending upwardly therefrom proximate to the outlet opening 146. As described previously, the posts 144 prevent a filter media insert (not shown in FIG. 13) from blocking the outlet opening 146.

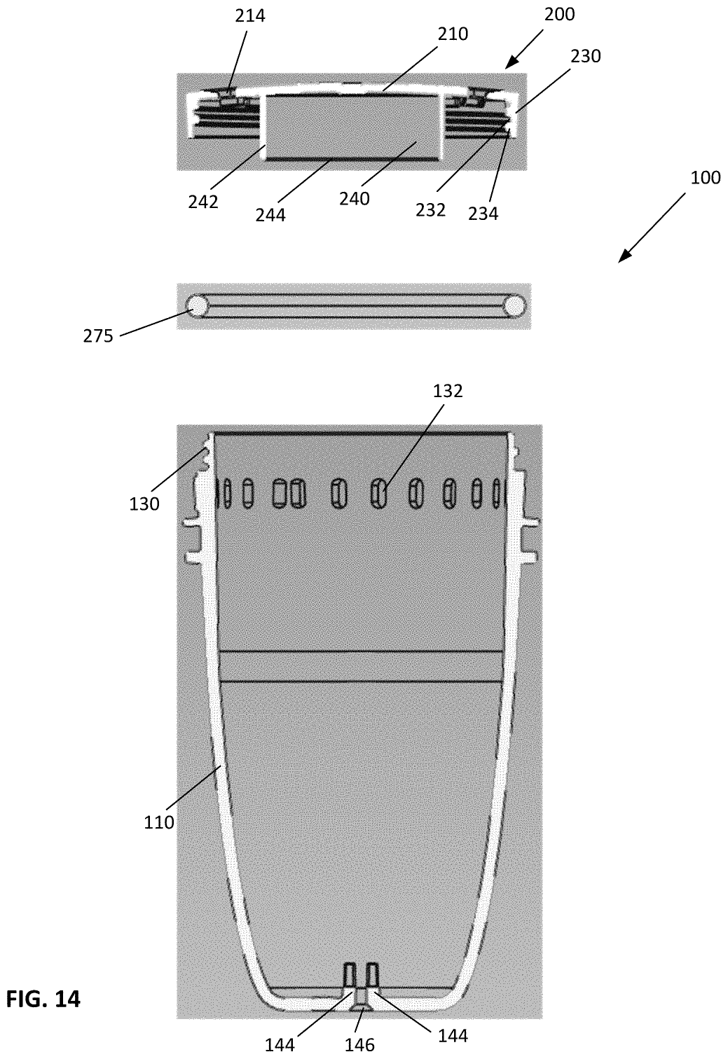

Referring to FIG. 14, an exploded view of the fluid filter components illustrated in FIG. 13 is shown. In this view, the fluid openings 132 spaced apart around the perimeter of the side wall of the housing 110 are shown. On the outer surface of side wall 120 proximate to the upper end 114 are threads 130 that are engaged by the cap 200. The threads 130 being on the outer surface allows more room to insert the filter media insert or pouch into the housing 110.

The cap 200 has an upper body or body portion 210 that has several openings 214 forming therethrough. The cap 200 also includes a downwardly extending side portion or collar 230. The side portion 230 has an inner surface 232 with threads 234 formed thereon. Threads 234 are configured to engage threads 130 on housing 110 to couple the cap 200 to the housing 110. Extending downwardly from the cap body 210 is an engagement portion 240. In this embodiment, the engagement portion 240 is a substantially circular or ring-shaped wall 242 that extends farther from the cap body 210 than the side portion 230 does. The wall 242 has a lower or engaging surface or edge 244 that contacts a filter media insert that is located in the cavity 150 of the housing 110.

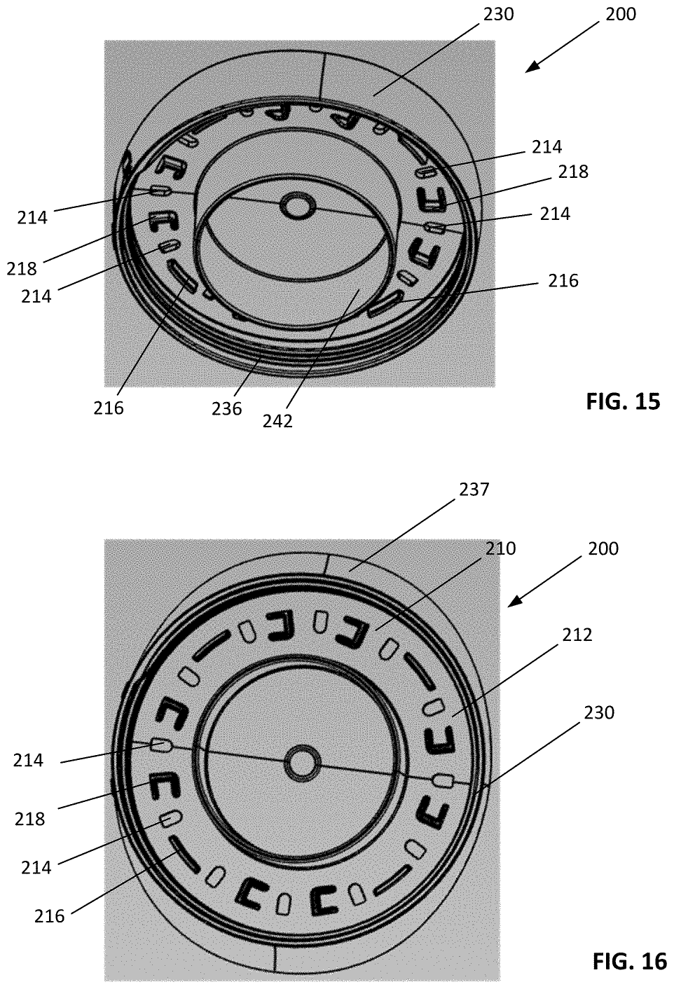

Referring to FIGS. 15 and 16, a bottom perspective view and a bottom view of the top or cap 200 of fluid filter 100 is illustrated. As previously described, the cap 200 includes a side portion 230 with threads 236 on its inner surface, and a body 210 through which openings 214 extend. In FIG. 16, the opposing tip portions 237 on opposite ends of the cap 200 are shown.

The body 210 of the cap 200 has an inner surface 212 with several structural components either coupled thereto or integrally formed therewith. In the illustrated embodiment, several spaced apart ribs 216 extend downwardly from surface 212. In this embodiment, there are four different ribs 216. In addition, several spaced apart u-shaped ramps 218 extend downwardly from surface 212. Each ramp 218 has a general u-shape with the distal ends of the u-shape extending the shortest distance from surface 212 and the bottom of the u-shape extending the greatest distance. As shown best in FIG. 16, there is either a rib 216 or a u-shaped ramp 218 located between adjacent openings 214 in a circular pattern surrounding the engagement member 240.

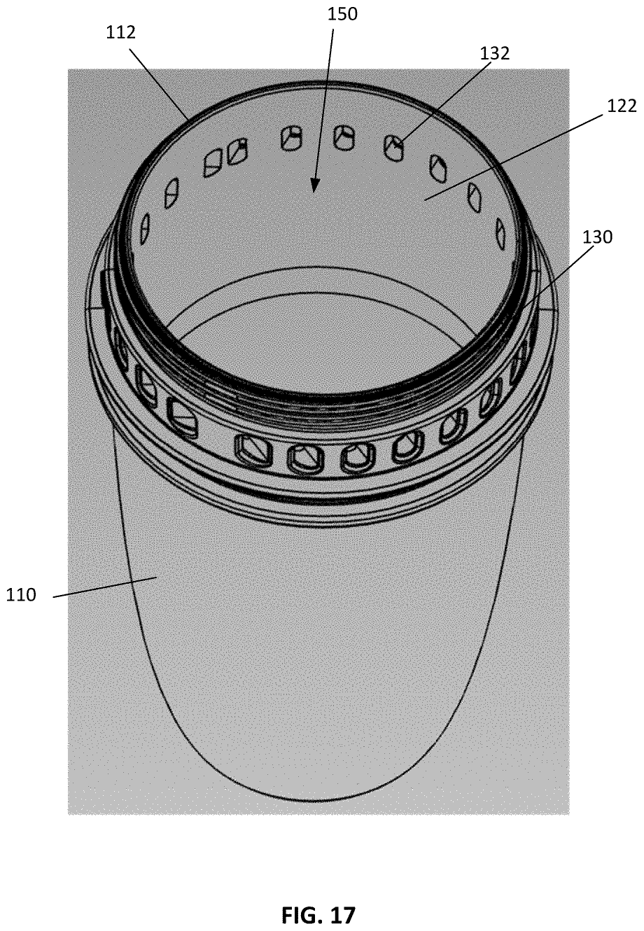

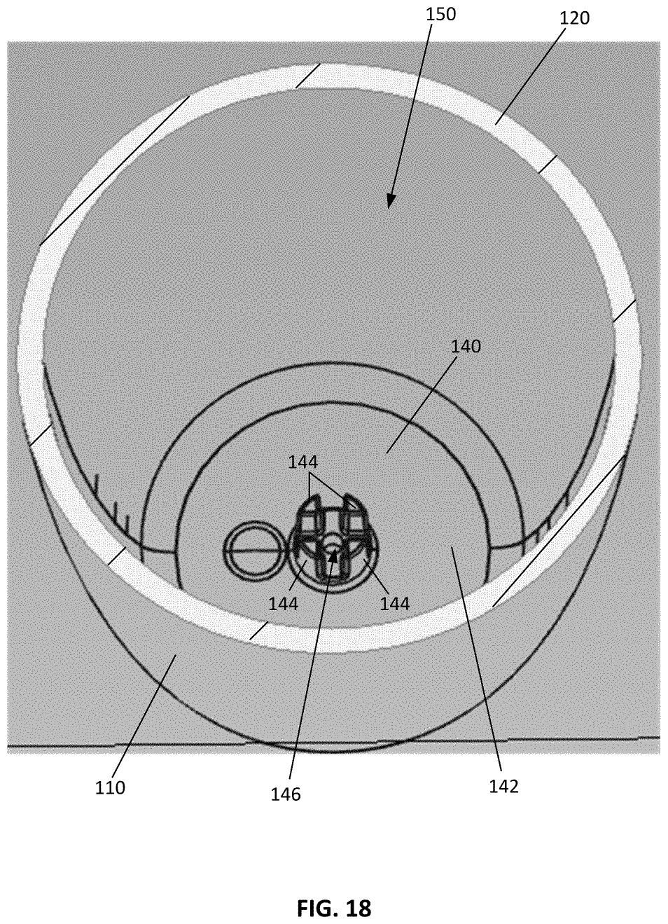

Turning to FIGS. 17 and 18, the housing 110 of fluid filter 100 is illustrated. In FIG. 17, the inner surface 122 of the side wall 120 of housing 110 is shown. The openings 132 extending through the side wall 120 are open to the inner surface 122 and in fluidic communication with the cavity 150. In FIG. 18, the components located at the bottom of the housing 110 are shown. In particular, the inner surface 142 of the bottom wall 140 includes several posts or projections 144 that form a spacing structure around the outlet opening 146. In this embodiment, there are four posts 144 that collectively define an outer perimeter in the shape of a cylinder. Each post 144 has two planar sides and one arcuate side. In different embodiments, the quantity and the shape of the posts can vary, provided that the posts sufficiently maintain the filter media insert away from the outlet 146. Flat tops of the four posts 144 ensure that the filter media insert or refill is not punctured when it is inserted into the housing 110. All configurations of the posts lift the filter media insert or refill up, thereby creating vertical inlets out of the space between the prongs or posts 144 and bottom of the refill and bottom of the housing or barrel.

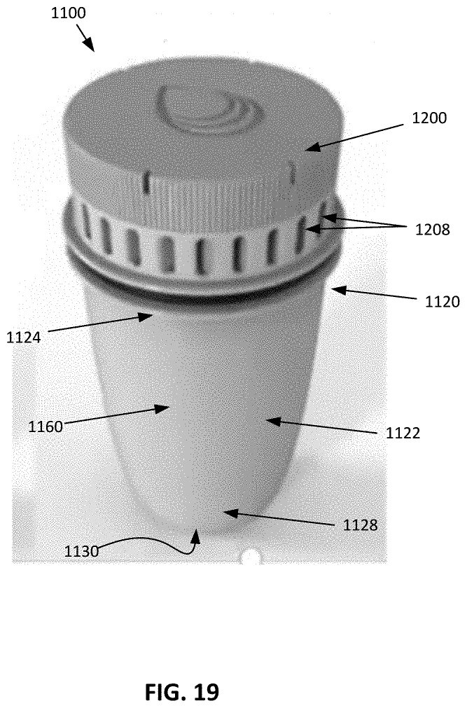

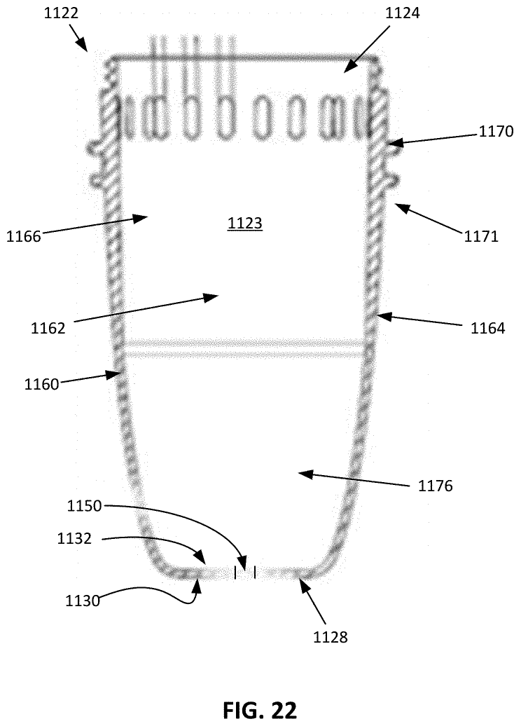

Now turning to FIG. 19, an alternative embodiment of a filter assembly 1100 formed in accordance with the present application is illustrated. At a high-level, the filter assembly 1100 includes a filter housing 1120, which in this embodiment is a two-part housing including a barrel or body 1122 and a closure element or cap or top 1200. The barrel 1122 extends from an open top 1124 to a bottom 1128 that is substantially closed, except for one or more orifices 1150 that extend therethrough (see FIG. 22). More specifically, the barrel 1122 includes a sidewall 1160 that extends from the open top 1124 to the bottom 1128. The sidewall 1160 and bottom 1128 may define an interior volume 1123 (see FIG. 22) within which a filter media insert can be removably secured. As is explained in further detail below, the sidewall 1160 may have one or more tapered portions and/or contours that can assist with positioning and/or guiding a filter media insert during insertion into the barrel 1122.

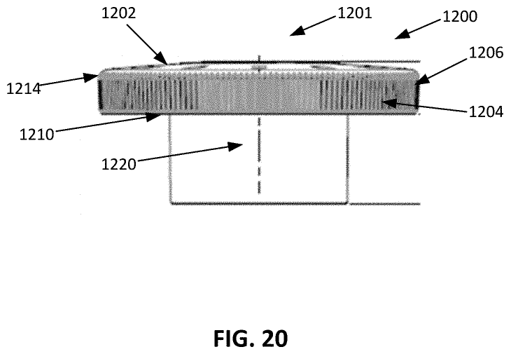

FIG. 20 shows the closure of the two-part filter housing 1120 of FIG. 19 in further detail. The closure element 1200 is removably securable to the barrel 1122 at or adjacent the open top 1124. Thus, the closure element 1200 can substantially close the interior volume 1123 to secure a filter media insert within the interior volume 1123. However, in at least some embodiments, the closure element 1200 only extends minimally into the interior volume 1123 to close the interior volume 1123—or does not extend into the interior volume 123 at all—to maximize the volume available for filtration media within the filter housing 1120. Additionally, in at least some embodiments, the barrel 1122, closure element 1200 and/or filter media insert are designed to minimize space between the filter media insert and the closure element 1200 (e.g., to minimize the air volume to vent) while also providing enough space to prevent an air lock from forming in the interior volume 1123.

In the depicted alternative embodiment (see FIG. 20), the closure element 1200 includes a main body 1201 that extends from a top surface 1202 to a bottom surface 1210. The main body 1201 is substantially disk shaped (e.g., cylindrical) and includes a grip 1204 disposed around its outer radial edge. However, in other embodiments, a closure element 1200 for a filter housing 1120 may be any shape and may include a grip or grip elements of any shape or size, arranged in any manner. For example, a grip may protrude from the top surface 1202 of the main body 1201 instead of being disposed on an outer radial edge of the main body 1201.

Still referring to FIG. 20, but now in combination with FIGS. 19, 21, and 22, in this embodiment, a first set of apertures 1206 for liquid or fluid and/or air are formed in or adjacent the grip 1204. Meanwhile, a second set of apertures 1208 for liquid or fluid and/or air are disposed on the barrel 1122, proximate the open top 1124. In this embodiment, the first set of apertures 1206 comprises six apertures equally spaced around the top surface 1202 and the second set of apertures 1208 includes approximately thirty inlets equally spaced around the sidewall 1160 of the body or barrel 1122. However, in other embodiments, a filter housing 1120 may include any number of apertures (which may act as liquid inlets and/or air vents), of any shape, arranged in any manner. For example, the closure element 1200 may include the first set of apertures 1206 arranged in different locations than those depicted and/or may include the second set of apertures 1208. Or, the closure element 2100 need not include the first set of apertures 1206, for example, if such features are included on another portion of filter housing 1120, such as barrel 1122.

Regardless of where the first set of apertures 1206 and/or the second set of apertures 1208 are positioned and/or how the apertures 1206 and/or 1208 are shaped/sized, preferably, the liquid inlets are arranged so that all or nearly water disposed in a reservoir supporting the filter assembly 1100 can enter the filter assembly 1100 when the filter assembly 1100 is installed in the reservoir. Moreover, in at least some embodiments, the first set of apertures 1206 and/or the second set of apertures 1208 are collectively large enough to avoid creating a flow restriction through the filter housing 1120. For example, the first set of apertures 1206 and/or the second set of apertures 1208 may provide a collective cross-sectional area that is larger than a collective cross-sectional area provided by one or more orifices 1150 (see FIG. 22) included in the bottom 1128 of the barrel 1122 so that the one or more orifices 1150 may govern the rate at which liquid flows through the filter housing 1120.

For simplicity, in the embodiment of FIGS. 19-22, the one or more orifices 1150 are depicted as a single orifice (see FIG. 22), but the bottom 1128 may include any number orifices, of any shape and size. In fact, embodiments with multiple orifices 1150 may include orifices of identical or differing dimensions. The one or more orifices 1150 may each extend from an inner surface 1132 of the bottom 1128 to an outer surface 1130 of the bottom 1128 to provide a pathway along which water in the interior volume 1123 can exit the interior volume 1123.

Regardless of the number and/or arrangement of the one or more orifices 1150, the one or more orifices 1150 may control the rate at which water exits the interior volume 1123 and, thus, may control a rate of filtration through the filter assembly 1100. For example, in some embodiments, the one or more orifices 1150 include a single hole with a diameter of approximately 1.8 mm or multiple holes with equivalent cross-sectional area and will create a flow rate of 5-10 minutes per liter (min/L) through the filter assembly 1100. Alternatively, the one or more orifices 1150 include a single hole with a diameter of approximately 2 mm to approximately 2.5 mm or multiple holes with equivalent cross-sectional area and will create a flow rate of approximately 3.3 min/L to approximately 8.3 min/L through the filter assembly 1100. In any case, controlling the flow rate with the one or more orifices 1150 may be critical because it may control the time that water passing through the filter is in contact with the filtration media of the filter media insert, which removes or reduces contaminants. Without this control, the filter assembly 1100 may be unable to satisfy industry standards required to support contaminant reduction advertising claims. Some heavy metal contaminants, such as cadmium and copper, have a slow kinetic reaction and therefore need more residence time with the filter media. Alternatively, a contaminant such as chlorine requires less residence time than a heavy metal contaminant. The reaction with or absorption of chlorine by the filter media happens faster, which reduces the sealing needed in the filter housing.

In some embodiments, the inner surface 1132 of the bottom 1128 may be rounded towards orifices to guide water to the one or more orifices 1150, but in other embodiments, the inner surface 1132 may be flat. In fact, it has been found that a flat inner surface 1132 creates more consistent flow rates as compared to a rounded inner surface 1132. This is because the flat inner surface 1132 allows water to pool at the bottom 1128 and create a constant and consistent backpressure at the one or more orifice 1150. Moreover, in at least some embodiments, the flat inner surface 1132 may better match the shape of the refill element, reducing air between bottom of filter and orifice which could slow or block the flow of water out of the bottom of the filter.

Generally, the closure element 1200 is configured to close the barrel 1122 and, thus, the bottom surface 1210 of the main body 1201 of the closure element 1200 includes an outer edge 1214 that at least spans the entire open top 1124 of the barrel 1122. For example, the outer edge 1214 may have a diameter that is slightly larger than a diameter of the open top 1124 and may thread onto interior or exterior threads included on the barrel 1122. Alternatively, the outer edge 1214 and/or the constraint 1220 may be configured to form a press or interference fit with the open top 1124 to create a seal between these two parts, e.g., with the outer edge 1214 and/or constraint 1220 disposed internally or externally of the open top 1124. In fact, in at least some embodiments, the closure element 1200 and/or the barrel 1122 may support a seal (e.g., an O-ring) configured to provide a seal between the outer edge 1214 and the open top 1124. However, these coupling options are merely examples and are not intended to be limiting in any manner.

As can be seen in FIG. 20, in this embodiment, the closure element 1200 also includes a constraint 1220 that engages the filter media insert to prevent or discourage the filter media insert from moving once seated in the interior volume 1123 (or at least to limit any such movement), as well as force the filter media insert to expand laterally in the cavity. This pressure from the constraint 1220 on the filter media insert decreases voids between the refill and the housing inner walls to mitigate bypass and ensure proper performance. In this embodiment, the constraint 1220 is a protrusion or protrusion-like member; however, in other embodiments, the constraint 1220 could be or include a biased element, such as a spring, that provides a downward force on the filter media insert.

Now referring to FIGS. 19 and 20, in at least this embodiment, both the barrel 1122 and the closure element 1200 are formed from a water impermeable material and, thus, sealing the closure element 1200 against the barrel 1122 ensures that any water entering the filter housing 1120 via the first set of apertures 1206 and/or the second set of apertures 1208 must flow through the filter housing 1120 and the filter media insert secured therein before exiting the filter housing 1120 via the one or more orifices 1150. That is, water entering filter housing 1120 via the first set of apertures 1206 and/or the second set of apertures 1208 cannot bypass the filter media insert by flowing through the material forming the filter housing 1120.

Moreover, generally, the engagement between the closure element 1200 and the barrel 1122 (e.g., via the outer edge 1214 of the closure element 1200 and the open top 1124 of the barrel 1122) is tight enough to secure a filter media insert within the interior volume 1123 of the barrel 1122, even when the filter housing 1120 is jostled or jolted, but the engagement is also loose enough to allow a user to easily remove the closure element 1200 from the barrel 1122. In some embodiments, the longitudinal force (e.g., upwards force) required to remove a disconnected closure element 1200 from the barrel 1122 may be less than the force required to remove the filter housing 1120 from a water filtration apparatus, such as a water pitcher. Thus, in some instances, a user may be able to decouple the closure element 1200 from the barrel 1122 (e.g., rotate the closure element 1200 to detach a threaded engagement) and remove the closure element 1200 from the barrel 1122 while the barrel 1122 remains installed in a water filtration apparatus.

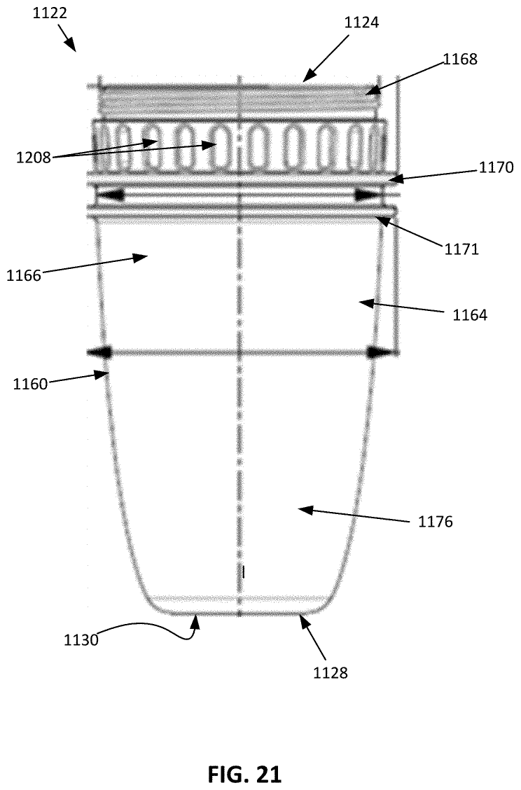

Now turning to FIGS. 21 and 22, as mentioned, in at least some embodiments, the barrel 1122 includes a sidewall 1160 with contouring and/or tapering. More specifically, the sidewall 1160 may include an inner surface 1162 and an outer surface 1164 and one or both of these surfaces may include contouring and/or tapering. Generally, contouring on the outer surface 1164 may ensure that the filter housing 1120 can fit into a particularly shaped filter receptacle of a water filtration apparatus (e.g., a filter receptacle in a pitcher).

By comparison, contouring on the inner surface 1162 engages the filter media insert and molds or shapes the filter media insert within the interior volume 1123 as the filter media insert seats in the interior volume 1123. In fact, the specific contouring causes the filter media insert to seat within the interior volume 1123 of the filter housing 1120 in a manner that distributes filtration media disposed within the filter media insert to expand radially, thereby increasing the radial footprint filtration media and causing the filtration media to seal against the inner surface 1162 of the sidewall 1160. In turn, this sealing mitigates bypass and ensures proper performance of the filter media insert.

In the embodiment depicted in at least FIGS. 21 and 22, the sidewall 1160 includes a proximal portion 1166 and a distal portion 1176. The proximal portion 1166 is substantially straight—e.g., shaped as a cylindrical annulus—while the distal portion 1176 is tapered to achieve the aforementioned advantages. Notably, in the depicted embodiment, the tapering of the distal portion 1176 is applied to the inner surface 1162 and the outer surface 1164; however, this is merely an example and other embodiments might include tapering on the inner surface 1162 that is different from of a shape of the outer surface 1164.

In one embodiment, the tapering of the distal portion 1176 is relatively parabolic, shifting through angles of approximately 7.5 degrees to approximately 30 degrees from vertical; however, in other embodiments, the angle can be constant, can increase and/or can decrease (constantly and/or non-constantly) towards the bottom 1128 of the barrel 1122. In fact, increasing the taper angle towards the bottom 1128 may serve to increase the distribution and expansion that mitigates bypass. That all said, in at least some embodiments, the specific angle (or angles) may be less than important than providing a taper profile that matches a taper profile of an insertion end of the filter media insert, as is described in further detail below.

Still referring to FIGS. 21 and 22, in this embodiment, an engagement element 1168 is included adjacent the open top 1124 (i.e., at the proximal end of the proximal portion 1166 of the sidewall 1160). In this embodiment, the engagement element 1168 comprises threads disposed on an outer surface of the sidewall 1160. The engagement element 1168 is also above the apertures 1208, which are longitudinally sandwiched between the engagement element 1168 and a flange 1170. However, in other embodiments, the barrel 1122 could include any desirable engagement element 1168, in any position, to allow the barrel 1122 to be removably coupled to the closure element 1200, including engagement elements that create a snap fit, a press fit, etc., as well as any combinations thereof. As a specific example, a receiver for a snap fit coupling might be sonically welded to the open top 1124 of the barrel 1122.

In this embodiment, the flange 1170 is advantageous because it extends radially outwards from the sidewall 1160 and defines an exterior seat 1171 between the flange 1170 and the sidewall 1160. The flange can engage a corresponding part of a water filtration apparatus to secure the filter assembly 1100 in place within the water filtration apparatus. Additionally, in at least some embodiments, this exterior seat 1171 can support a seal (e.g., an O-ring) that can prevent water from flowing between the filter housing 1120 and a water filtration apparatus within which the filter housing 1120 is installed/seated. However, in this embodiment, the flange 1170 defines a channel configured to receive a seal (e.g., an O-ring) that can prevent water from flowing between the filter housing 1120 and a water filtration apparatus within which the filter housing 1120 is installed/seated. Still other embodiments might include seals (e.g., O-rings) in both locations. That is, one or more seals may be positioned on the flange 1170 and/or exterior seat 1171 to prevent water from bypassing the interior volume 1123 of the filter housing 1120. In some embodiments with such a seal, the seal may be designed to withstand at least twenty-four insertion/removal cycles of the filter housing 1120 into and out of the water filtration apparatus.

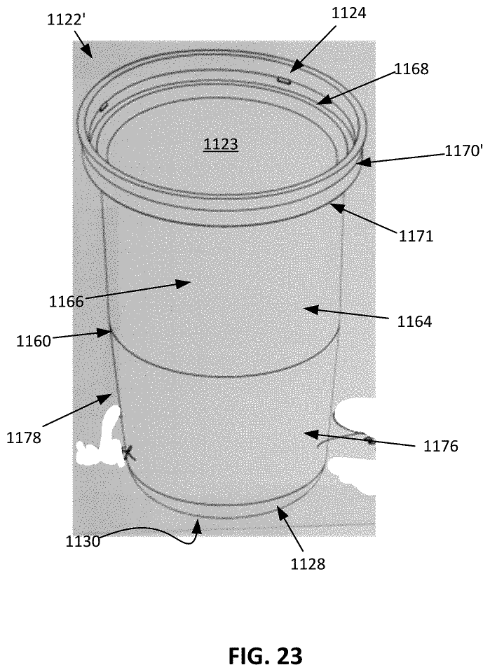

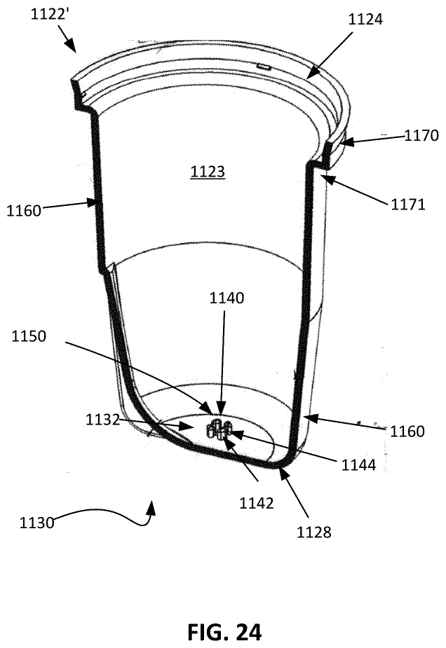

Now turning to FIGS. 23 and 24, another alternative embodiment of a barrel that may form a filter housing for a filter assembly is illustrated. In this embodiment, barrel 1122′ is substantially similar to barrel 1120 and, thus, any description of components or features of barrel 1122 included herein should be understood to apply to like or similar components of barrel 1122′. In fact, for simplicity, components of barrel 1122′ that are similar or identical to components of barrel 1120 are labeled with like numbers. That said, there are at least four notable differences between barrel 1122 and 1122′.

First, a specific radial location of the outer surface 1164 of barrel 1122′ is contoured inwards to provide space for a fin 1178 to extend from this radial location. This fin 1178 and the associated contouring may be sized to fit within corresponding features of specific filter receptacles of specific water filtration apparatuses, and may also align or key the filter housing 1120 in a specific orientation within such apparatuses. Second, aside from the contouring associated with the fin 1178, the tapering of the distal portion 1176 is relatively constant, such as at an angle of approximately 7.5 degrees to approximately 30 degrees from vertical.

Third, the flange 1170′ of barrel 1122′ is defined adjacent the open top 1124 of the barrel 1122′ and does not include a channel. Instead, the flange 1170′ might include apertures that allow liquid to enter and air to vent from the interior volume 1123. Additionally or alternatively, barrel 1122 may be configured to connect with as closure element 1200 that includes such features (e.g., a closure element 1200 with apertures 1206 and apertures 1208).

Fourth, in the embodiment of FIGS. 23 and 24, each of the one or more orifices 1150 is, in essence, protected by an orifice guard 1140. For simplicity, FIG. 24 depicts the one or more orifices 1150 as a single orifice but, to reiterate, the bottom 1128 may include any number orifices, of any shape and size. In any case, the orifice guard 1140 provides separation between the one or more orifices 1150 and the filter media insert disposed in the interior volume 1123. This may prevent a containment layer of the filter media insert from clogging or otherwise slowing flow rates through the one or more orifices 1150. Notably, slowing the flow rate through the one or more orifices 1150 could lead to variable flow rates and/or create preferred paths for water to flow within the filter, which decreases efficacy of media in those paths and leads to a shorter filter life.

In the embodiment depicted in FIG. 24, the orifice guard 1140 includes four posts 1142 that are radially spaced around a single orifice 1150. The posts 1142 are also spaced from each other by gaps 1144. Consequently, the orifice guard 1140 allows water to flow laterally towards the one or more orifices 1150 (via gaps 1144) or flow longitudinally to the orifice (from a location directly above the orifice). But, at the same time, the posts 1142 provide a physical barrier (e.g., a cage) around an orifice that mitigates detrimental flow conditions that might be created from a filter media insert directly contacting the one or more orifices 1150. In some embodiments, the posts 1142 extend approximately 0.25 inches from the inner surface 1132 of the bottom 1128, but other embodiments may include posts of any desirable height (and any other dimensions may also vary as desired).

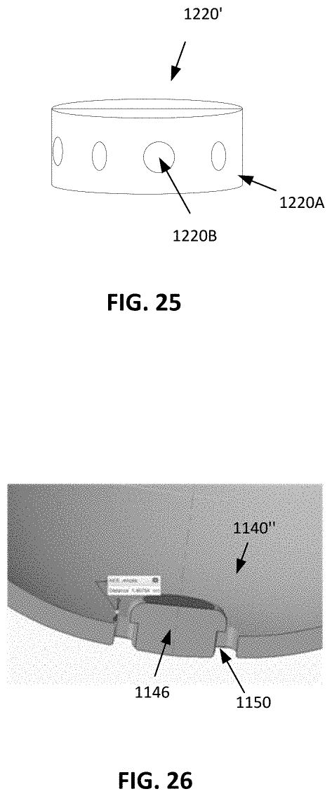

While the orifice guard 1140 is illustrated in barrel 1122′, the orifice guard 1140 could also be included in barrel 1122. Moreover, an orifice guard included in any barrel of a filter housing 1120 of the filter assembly 1100 presented herein need not have the structures and features of orifice guard 1140. To illustrate this, FIGS. 25 and 26 show two additional embodiments of orifice guards.

First, FIG. 25 illustrates an alternative embodiment of an engagement member 1220′ that could also be incorporated into filter housing 1120 (or any other embodiment presented herein). In this embodiment, the engagement member 1220′ is formed by a cylindrical component 1220A with bores or openings 1220B formed therein.

Moreover, although FIG. 25 illustrates bores 1145 as circular openings evenly spaced around the cylindrical component 1143, an orifice guard 1140′ may include any number of bores (or gaps), of any shape, arranged in any arrangement. In fact, the bores 1145 need not be straight and could be skewed to create a swirl, have narrowing and/or widening diameters (e.g., to create a change in pressure and flow), or any other desirable features to control flow of water towards the one or more orifices 1150. However, the sum of the surface areas of the bores 1145 should be greater than that of the orifice 1150 to which the bores 1145 lead to allow the outlet orifice 1150 to be the main control of flow rate. Alternatively, the sum of the surface areas of the bores 1145 could be less than that of the outlet orifice 1150 to which the bores 1145 lead so that the bores 1145 control the flow rate of the filter assembly 1100. In one embodiment, a flow rate of less than 10 min/L is desired.

Next, in FIG. 26, the orifice guard 1140″ is or resembles a plug 1146 that can block a portion of an orifice 1150. In some instances, the plug 1146 may have an elliptical head to allow it to seal in a circular orifice 1150 without falling therethrough. Additionally or alternatively, an orifice might be irregularly shaped to allow a plug 1146 to sit therein without falling therethrough. Still further, in some instances, the plug 1146 might be undercut and/or include bores in selective locations to allow water to flow through the plug 1146 and/or orifice 1150 when the plug 1146 is sitting in the orifice 1150.

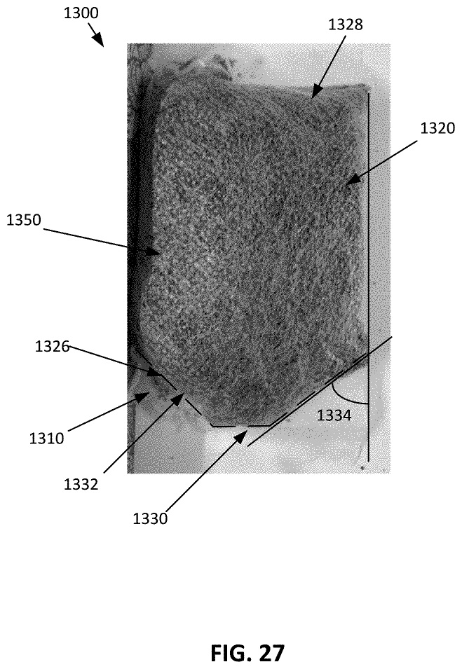

Now turning to FIG. 27, one example embodiment of a filter media insert that may be used with the filter assemblies presented herein is illustrated. The filter media insert 1300 illustrated in FIG. 27 may be particularly advantageous when used with a closed filter housing, such as filter housing 1120. In this embodiment, the filter media insert 1300 comprises a pouch 1320 that is formed by a containment layer 1310 and filled with a granular filtration media 1350. In this embodiment, the containment layer 1310 is a drapeable (i.e., malleable) material so that it can deform or drape against a filter housing, especially in response to a downward force, such as a downward force created by a constraint element of a closure acting on a top or grippable end 1328 of the pouch 1320 (e.g., the constraint 1220 of closure element 1200). In other words, the containment layer 310 can hang downwardly. The flexibility (i.e., malleability and/or drapability) of the containment layer 1310 allows it to expand outwards against a filter housing (e.g., against inner surface 1162 of sidewall 1160 of filter housing 1120) and conform to the shape of the housing. In addition, the pouch 1320 flexes or stretches under the vertical pressure or constraint to conform to the shape of the filter housing 1120. Then, granules of the filtration media 1350 contained within the containment layer 1310 can form a complete radial seal (e.g., 360 degrees) against the filter housing and prevent water flowing through the filter assembly 1100 from bypassing the filtration media 1350.

As can be seen in FIG. 27, the pouch 1320 extends from a grippable end 1328 to an insertion end 1330. Critically, the grippable end 1328 may be rounded, domed, or have any other non-flat shape. Since the grippable end 1328 acts as the water inlet of the pouch 1320 during filtration operations, the non-flat (i.e., non-planar) shape may allow water to enter the filter media insert 1300 while still allowing the inlet of the pouch 1320 to effectively vent to discourages or prevent air lock. Or, put simply, the non-flat shape allows space for air to accumulate and then vent while water is entering the pouch 1320.

Additionally, in at least some embodiments, the pouch 1320 and/or filtration media 1350 are selected so that a user can grasp the grippable end 1328 and remove the filter media insert 1300 from a filter housing supporting the filter media insert 1300 (e.g., filter housing 1120) with a force that is less than the force required to remove the filter housing from a water filtration apparatus. Thus, a user will be able to remove the filter media insert 1300 from a filter housing (e.g., filter housing 1120) while the filter housing remains installed in a water filtration apparatus. Still further, in at least some embodiments, the grippable end 1328 may include fabric that overhangs a seal, a handle, or any other such feature to minimize the need for user to touch the pouch 1320 and/or the filtration media 1350 included therein during installation of the filter media insert 1300 into a filter housing (e.g., filter housing 1120) and/or a water filtration apparatus.

Meanwhile, in this embodiment, the insertion end 1330 has chamfered edges 1332 that are angled at a single, linear chamfer angle 1334 of approximately 7.5 degrees to approximately 30 degrees from vertical. Generally, the chamfered edges 1332 create a taper that makes the pouch 1320 easy to insert into a filter housing and helps evenly distribute filtration media 1350 so that the filtration media 1350 sits flush against an inner surface of a filter housing. However, in other embodiments, the chamfer angle 1334 need not be linear and can increase and/or decrease (constantly and/or non-constantly) towards the insertion end 1330. In fact, increasing the taper angle towards the insertion end 1330 may serve to increase the distribution and expansion that mitigates bypass. But, as mentioned, in at least some embodiments, the specific angle (or angles) may be less important than providing a taper profile that matches a taper profile of an inner surface 1162 of a sidewall 1160 of a filter housing 1120. This is because matching taper profiles may generally align and, thus, may draw filter media as close to a filter housing over as much surface area as possible, without requiring the pouch 1320 to contort, bulge, or otherwise move unnaturally.

In this embodiment, the pouch 1320 is formed with a three-sided seal and the chamfered edges 1332 are formed with a K-seal 1326 formed along the insertion end 1330. However, in other embodiments, the pouch 1320 may be formed with fin sealing techniques (e.g., a fold-over seam along a center of the pouch 1320). Either way, all edges of the pouch 1320 may be sealed so that water enters and exits the pouch 1320 via the permeable substrate forming the containment layer 1310 instead of through an orifice or opening formed in or defined by the containment layer 1310). The seal or seals may be formed in any desirable manner, including ultrasonic sealing, regardless of the method of sealing (e.g., fin or three-sided).

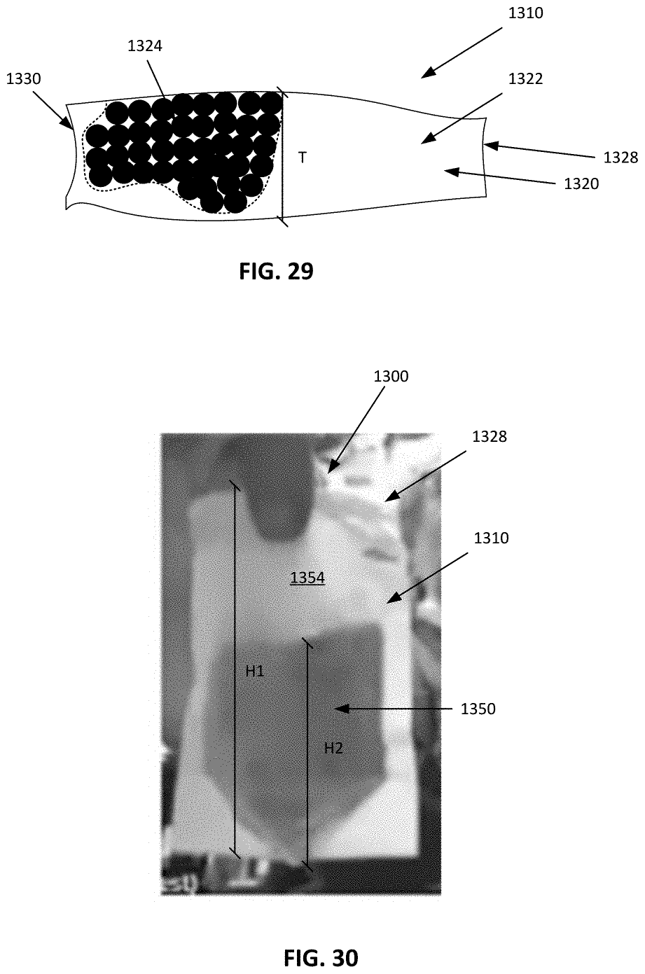

Moreover, regardless of the type of seal and/or the method in which the seal is achieved, the pouch 1320 defines an interior volume 1322 (see FIG. 29) that is substantially closed and securely holds the filtration media 1350 without risk of the filtration media 1350 exiting the filter media insert 1300 during a filtration operation. Leakage of filtration media 1350 from the containment layer 1310 generally decreases filtering effectiveness and/or the lifespan of the filter media insert 1300 and may also create a drinking hazard and/or detrimental aesthetic for an end user. Thus, carefully securing the filtration media 1350 within the containment layer 1310 avoids these issues. Moreover, constraining the filtration media 1350 within a pouch 1320 and limiting the orifice to a single orifice has been found to improve the contaminant reduction efficiency of filtration media 1350 and thus, a filter media insert 1300 may be able to include less filtration media 1350 as compared to a filter media insert 1300 with unconstrained filtration media 1350 (e.g., a filter with filtration media 1350 disposed directly in a filter housing). In turn, reducing the quantity of filtration media 1350 included in the filter media insert 1300 may reduce the amount of waste created by the filter media insert 1300.

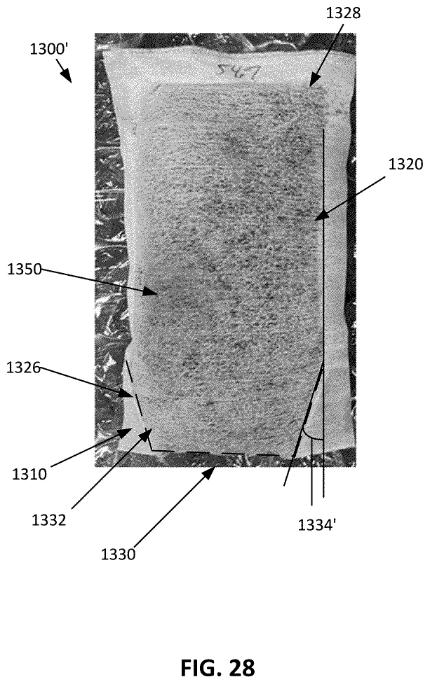

As mentioned, in different embodiments the filter media insert may have different dimensions. As an example of this, FIG. 28 depicts a filter media insert 1300′ that is substantially similar to the filter media insert 1300 of FIG. 27, except for its dimensions. Thus, any description of components or features of filter media insert 1300 included herein should be understood to apply to like or similar components of filter media insert 1300′. In fact, for simplicity, components of filter media insert 1300′ that are similar or identical to components of filter media insert 1300 are labeled with like numbers. The main dimensional difference is that filter media insert 1300′ includes a chamfer angle 1334′ that is smaller than chamfer angle 1334 and, thus, creates a steeper chamfer as compared to the chamber of filter media insert 1300.

Now turning to FIG. 29, which is a schematic side view of the filter media insert 1300 of FIG. 27, the media containment layer 1310 is formed from a water-permeable, spunbonded or spunlaced non-woven fabric substrate. At a high-level, the containment layer 1310 is water-permeable because fabric substrate used to form containment layer 1310 includes pores 1324. To illustrate this, pores 1324 are generally depicted as circular pores on a portion of containment layer 1310 in FIG. 29, but these pores 1324 are representative of pores that may extend over an entirety of containment layer 1310 (or any portion thereof). Additionally, the circles shown in FIG. 29 are merely schematic illustration of pores and are not intended to be limiting in any manner (e.g., these illustrations do not limit pores 1324 to specific shapes, arrangements, or sizes). Instead, the pores 1324 are generally sized so that a porosity of the containment layer 1310 is small enough to prevent filtration media 1350, or black “flecks” created by the filtration media 1350, from passing through the pores 1324. For instance, the pores may have a diameter equal to or smaller than 220 μm. Additionally, the pores 1324 may be sized to prevent pore matching of the filtration media 1350 and the containment layer 1310, which would block flow through the containment layer 1310.

At the same time, in at least some embodiments, the pores 1324 do not control a flow rate through the filter assembly 1100 and, thus create a flow rate that is faster than or equal to the overall flow rate through the filter assembly 1100 (so that another feature may control the flow rate). For example, the pores 1324 may be sized to allow a flow rate equal to or faster than that the flow rate created by the one or more orifices 1150 included on the filter housing 1120 of the filter assembly 1100. Thus, the pores 1324 may create a flow rate equal to or greater than a flow rate in the range of approximately 3.3 min/L to approximately 8.3 min/L, such as a flow rate equal to or greater than a flow rate in the range of 7-8 min/L. In fact, when the flow rate is controlled downstream of a filter media insert 1300 (e.g., by the one or more orifices 1150 of filter housing 1120), a filter media insert 1300 may be able to include less filtration media 1350 as compared to a filter media insert 1300 that controls flow. As mentioned above, reducing the quantity of filtration media 1350 included in the filter media insert 1300 may reduce the amount of waste created by the filter media insert 1300.

In at least some embodiments, the aforementioned properties/characteristics (e.g., flow rate, secure constraint of filtration media 1350, etc.) are achieved by forming the containment layer 1310 from a hydrophilic material, which may assist permeability. For example, the containment layer 1310 may be formed from a spunbonded polyester (e.g., polyethylene terephthalate (PET)) or a modified (e.g., coated or blended) Polypropylene non-woven fabric, at a basis weight of approximately 20 grams per square meter (gsm) to approximately 50 gsm. Other options include a coated polypropiolactone (PPL) and/or blends of materials, such as PET blended with 30% Polyethylene (PE), a blend of PPL and PE, and so forth. Generally, blending low-melt resins into a non-woven fabric may assist with sealing. Additionally or alternatively, in at least some embodiments, the containment layer 1310 may include an anti-microbial additive (e.g., when formed from a non-woven fabric). However, to be clear, the foregoing description of materials only relates to some embodiments and other embodiments of the filter media insert 1300 need not include a containment layer 1310 formed from a water-permeable, spunbonded or spunlaced non-woven fabric substrate. Instead, other embodiments may include a containment layer 1310 formed from any number of materials, including inflexible (i.e., rigid) and/or impermeable materials (e.g., materials without pores). Examples of some other such embodiments are described in further detail below.

Now turning to FIGS. 29 and 30, but with continued reference to FIGS. 27 and 28, generally, pouch 1320 is sized to receive an amount of filtration media 1350 sufficient for proper filtration performance, but is also sized to allow expansion of this filtration media 1350. At the same time, the overall profile of the pouch 1320 is minimized to, among other advantages, minimize the shipping materials needed to transport the filter media insert 1300 (e.g., during manufacturing, distribution, sale, resale, etc.). More specifically, when in a horizontal position/orientation (e.g., when lying on a horizontal surface), as is depicted in FIGS. 27, 28, and 29, the pouch 1320 may have a maximum thickness T that is sized to fit in an envelope. For example, maximum thickness T may be approximately 0.75 inches or less when the filter media insert 1300 is in a horizontal position (e.g., lying on a horizontal surface). But, the maximum thickness T need not be the maximum thickness of the pouch 1320. Instead, the flexibility of the containment layer 1310 may also allow the filter media insert 1300 to shift in shape/profile when the filter media insert 1300 is moved from a horizontal position to a vertical position, as is illustrated in FIG. 30.

The volume of any ion exchange material in the filter media decreases approximately 40% when it becomes dehydrated. Accordingly, any filter media containing ion exchange materials should be shipped in a moisture proof pouch or bag to keep the media hydrated. That will facilitate the proper insertion of the filter media insert into the housing. When ion exchange material is hydrated, it swells and its volume increases. Ideally, the material of the filter media insert or pouch can expand and be drapeable to handle media swelling. Another factor that affects the filter media and its performance in the fluid filter is the ratio of volume of media hydrated relative to the void space in the housing.

Specifically, referring to FIG. 30, the overall height H1 of the pouch 1320 may allow the filtration media 1350 to be spread over the entirety of the pouch 1320 when the pouch 1320 is in a horizontal position. Then, when the filter media insert 1300 is moved from a horizontal position to a vertical position, the filtration media 1350 may naturally move/flow towards the insertion end 1330 and occupy a portion of the overall height H1 of the pouch 1320, as is indicated by vertical height H2. As can be seen in FIG. 30, this also creates air space 1354 above the filtration media 1350. This air space 1354 provides space to accommodate expansion of the filtration media 1350 and must be carefully managed to allow expansion while also allowing venting and preventing air lock. Additionally or alternatively, the air space 1354 might be compressed/condensed by a constraint element of a closure (e.g., the constraint 1220 of closure 1200). Thus, on balance, the overall size of the pouch 1320 (including height H1) must be carefully designed to control the size of the air space 1354 while also controlling the maximum thickness T of the pouch 1320 when in a horizontal position (e.g., when lying on a horizontal surface). In one example, the pouch measures approximately 5.51″ (height) by approximately 3.12″ (width) by approximately 0.60″ (depth) when horizontal.

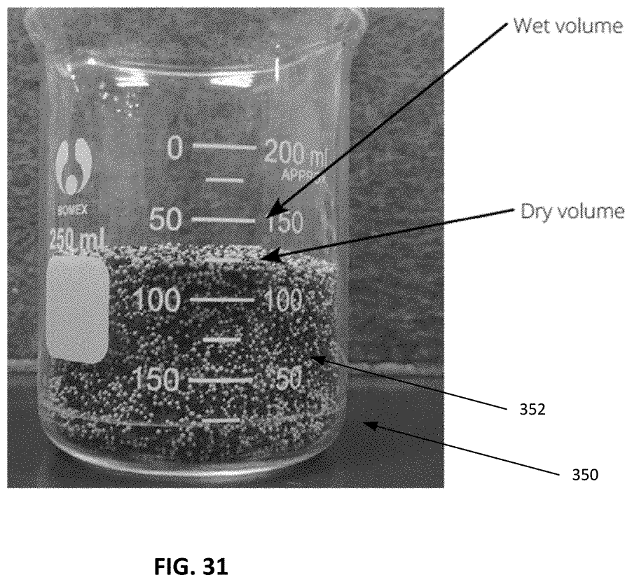

Now turning to FIG. 31, this figure illustrates the filtration media 1350 expansion concept mentioned above. As can be seen, initially, a filtration media 1350 will have a dry volume. Then, when exposed to water, the filtration media 1350 may absorb at least some of the water and expand. In this example, the dry volume is approximately 125 milliliters (ml, but also frequently described as a cubic centimeters (ccs)) and the wet volume is approximately 150 ml (e.g., 150 ccs). Thus, when wetted, the filtration media 1350 expands to approximately 120% of its dry volume. However, in other embodiments, the filtration media 1350 may have a dry volume of approximately 85 cc to approximately 110 cc, such as approximately 85-105 cc or approximately 90-110 cc. Moreover, in other embodiments, the filtration media 1350 may expand to approximately 105% to approximately 150%, or more, of its dry volume, depending on the composition of the filtration media 1350.

Generally, the filtration media 1350 is formed from a granular adsorptive media which, for the purposes of this application, may be referred to as granules 1352 and may include any granular or loose fiber form which can be held within the containment layer 1310 without passing through or blinding the containment layer 1310 and which can conform to the shape of a filter housing, such as filter housing 1120. Additionally, in at least some embodiments, the granules 1352 are able to sit within the containment layer 1310 without causing channels to form in or between the granules 1352, between the granules 1352 and the containment layer 1310, or between the granules 1352 and a filter housing, such as filter housing 1120. Still further, in at least some embodiments, the granules have a turbidity greater than approximately 4 Nephelometric Turbidity units (ntu). As a specific example, the granules 1352 may include a mix of ion exchange resin (IER), such as 12×50 mesh IER, and granular activated carbon (GAC), such as 18×40 mesh GAC. More specifically, the granules 1352 may include approximately 45% IER and approximately 55% GAC measuring about approximately 0.3 mm to approximately 1.6 mm and may provide a hydrated bed volume of 90 to 120 cc.

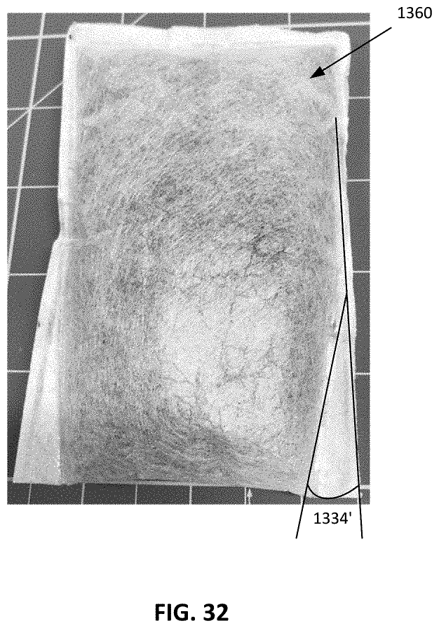

Now turning to FIGS. 32, 33, and 34, alternative embodiments of filter media inserts that may be used with a substantially closed filter housing (i.e., a filter housing that encapsulates a filter media insert), such as filter housing 120, are illustrated. For brevity, only differences between these embodiments and previously described embodiments are discussed herein and any description of like parts included above should be understood to apply to these alternative embodiments.

Referring to FIG. 32, the filter media insert 1360 includes a steeper chamfer angle 1334′ as compared to the chamfer angle 1334 of FIG. 27. As is discussed above, in some instances, it may be helpful, but not necessary, to match a taper profile of a filter media insert with a taper profile of a filter housing. Thus, since angle 1334′ may match different housing chamfer as compared to angle 1334, filter media insert 1360 may provide compatibility with different filter housings.

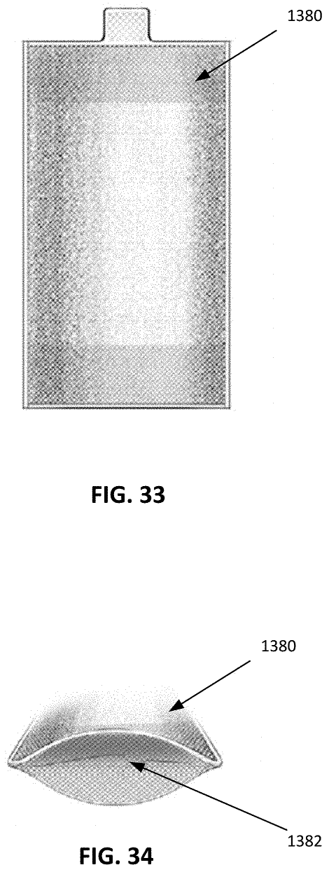

Referring to FIGS. 33 and 34 illustrate a filter media insert 1380 that is substantially elliptical (from a bottom or top view), but includes a self-folding or gusseted bottom 1382 that may encourage the filter media insert 1380 to remain as flat as possible when in a horizontal position (e.g., when lying on a horizontal surface). To be clear, any combination of these features may be incorporated into any filter media insert (e.g., filter media insert 1300), alone or in combination with any other features.

In different embodiments, a variety of materials may be used to form a containment layer for a filter media insert that is usable with embodiments presented herein. One category of materials that can be used to form a containment layer are hydrophilic and/or permeable materials. Some examples of such materials include nylon plastic mesh material, a carded non-woven fabric, and an interfacing fabric. Alternatively, another category of materials that can be used to form a containment layer hydrophobic and/or non-permeable materials. Some examples of such materials include film and non-woven materials, a 45 gsm non-woven fabric, and a 15 gsm non-woven fabric. Any combination of these example materials, or other materials, may also be utilized to form a containment layer for a filter media insert usable with embodiments presented herein.

The non-woven pore size (denier) is important to keep the filter media in the filter media insert as well as achieve a consumer acceptable flow rate. In one embodiment, the filter media insert is formed of a polyester material. The permeability of the filter media insert material is also an important factor.

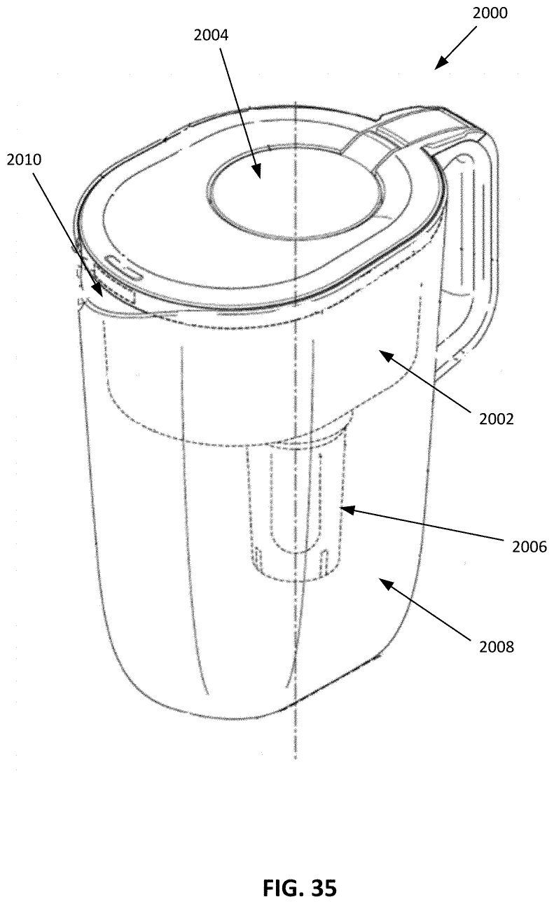

FIG. 35 is a front perspective view of a water filtration apparatus 2000 with which the filter assemblies presented herein may be used. In this embodiment, the apparatus 2000 is in the form of a pitcher; however, this is merely an example and is not intended to be limiting in any manner. At a high-level, the apparatus includes a first reservoir 2002 configured to receive unfiltered water through inlet 2004 that is covered by a pivotable lid. A filter receptacle 2006 is included at a bottom of the first reservoir 2002 and is configured to support a filter assembly formed in accordance with the present application. As water flows through a filter assembly disposed in the filter receptacle 2006, the water enters a second receptacle 2008. Then, when a user wants to drink filtered water, the user can pour filtered water from second receptacle 2008 through spout 2010. In an alternative embodiment, the apparatus does not have a filter receptacle 2006, and the fluid filter sits in a reservoir hole.

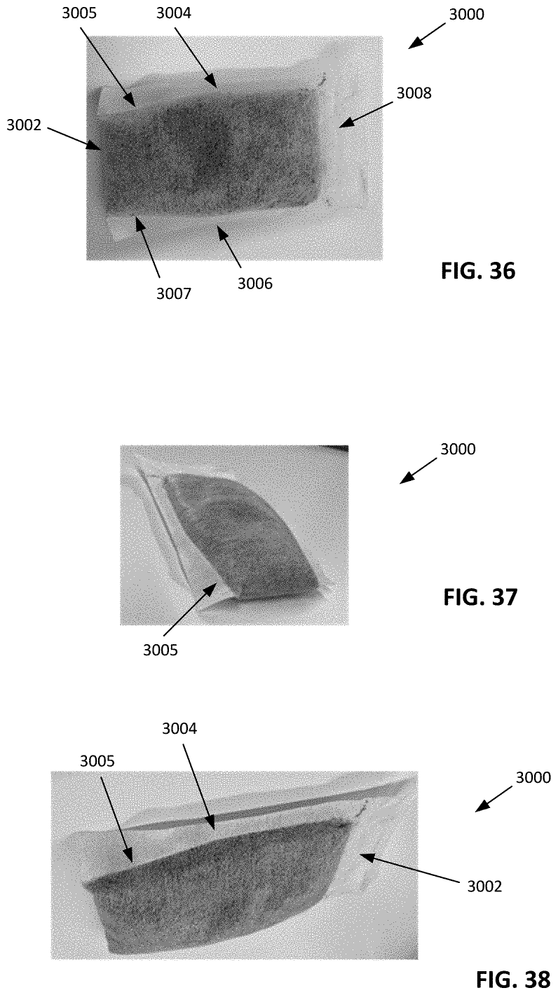

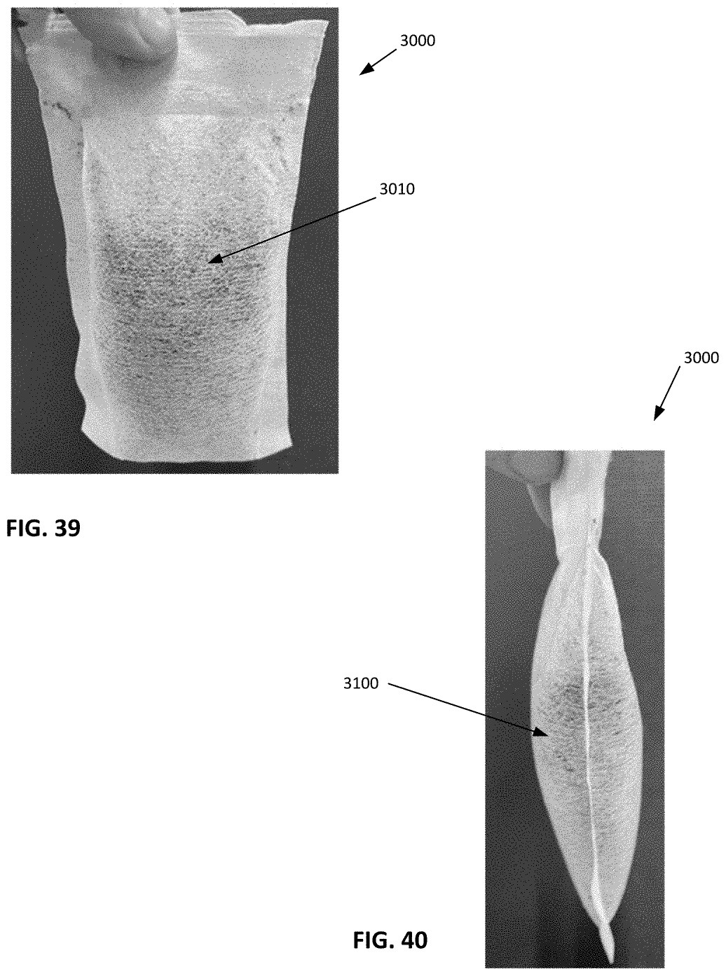

FIGS. 36-40 are different views of another embodiment of a filter media insert according to the present disclosure. In this embodiment, the filter media insert 3000 is a drapeable pouch made of a porous material. The pouch has a bottom end 3002, opposite side portions 3004 and 3006, and a top end 3008 that is sealed closed after the filter media 3010 is placed inside of the insert 3000. In one embodiment, the side portions 3004 and 3006 are coupled together using any standard method or technique. As shown, in this embodiment, each of the side portions 3004 and 3006 has a tapered portion 3005 and 3007, respectively, that results in the side portions having a greater thickness closer to the bottom end 3002 than at the top end 3008. As a result, the filter media is closer to the edges of the side portions 3004 and 3006 in their non-tapered portions.

In an alternative embodiment, the housing of the fluid filter can be built in the reservoir of the filtering apparatus, thereby eliminating the need for an O-ring. In another embodiment, the fluid filter housing can have a horizontal orientation instead of a vertical orientation. In that arrangement, the filter media insert can be mounted in a receptacle, such as a rectangular horizontal well.

While this application has described the techniques presented herein in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Finally, for the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A fluid filter that can be located in a dispensing apparatus that has a first region in which an unfiltered fluid is located and a second region in which a filtered fluid is collected, the fluid filter comprising:
a housing located to receive the unfiltered fluid from the first region, the housing including a wall having an inner surface and a bottom surface that collectively define a cavity, an inlet opening through which unfiltered fluid passes into the cavity, and an outlet opening through which filter fluid passes from the cavity, the housing defining a flow path for fluid passing therethrough between the inlet opening and the outlet opening;
a top removably coupled to the housing, the top including an engagement portion extending therefrom; and
a drapeable container having a filter media located therein, the drapeable container being insertable into the cavity when the top is removed from the housing, wherein one of the engagement portion of the top or the bottom surface of the housing applies a force on the drapeable container, the drapeable container and the filter media extending across the flow path when the drapeable container is located in the housing, thereby ensuring that fluid passing from the inlet opening to the outlet opening engages the drapeable container and the filter media so that at least one contaminant is reduced from the fluid passing through the fluid filter.

2. The fluid filter of claim 1, wherein the wall of the housing extends around an inner perimeter of the cavity, and the drapeable container engages the inner surface of the wall around the inner perimeter of the cavity.

3. The fluid filter of claim 1, wherein the applied force from the engagement portion causes the drapeable container to expand laterally to contact the inner surface of the wall.

4. The fluid filter of claim 1, wherein the engagement portion is substantially ring-shaped.

5. The fluid filter of claim 1, wherein the engagement portion is coupled to a biasing member that biases the engagement portion toward the drapeable container located in the housing.

6. The fluid filter of claim 1, wherein the housing includes an inner bottom surface, and when the drapeable container is engaged by the engagement member, the drapeable container engages the inner surface of the wall continuously around the cavity to seal the flow path between the inlet opening and the outlet opening.

7. The fluid filter of claim 1, wherein the drapeable container is formed of at least one wall member made of a porous material, the at least one wall member defining a compartment in which the filter media is located, and the fluid flowing from the inlet opening to the outlet opening flows through the at least one wall member and engages the filter media in the drapeable container.

8. The fluid filter of claim 1, wherein the housing has an upper end and a lower end opposite the upper end, the housing wall extends from the upper end to the lower end and is tapered from the upper end to the lower end, and the cavity defined by the inner surface of the wall has a first inner diameter proximate to the upper end and a second inner diameter proximate to the lower end, the first inner diameter being larger than the second inner diameter.

9. The fluid filter of claim 1, wherein the housing has an inner bottom surface and at least one post extending upwardly from the inner bottom surface, and the at least one post is proximate to the outlet opening and engages the drapeable container when the drapeable container is in the cavity to prevent the drapeable container from blocking the outlet opening.

10. The fluid filter of claim 9, wherein the housing includes four spaced apart posts extending upwardly from the inner bottom surface, and each of the posts engages the drapeable container when the drapeable container is in the cavity.

11. The fluid filter of claim 1, wherein the housing has an inner bottom surface with a spacing structure extending upwardly therefrom, and the spacing structure engages the drapeable container to prevent it from blocking the outlet opening.

12. A fluid filter for removing a contaminant from a fluid, the fluid filter comprising:
a housing including a wall and a bottom surface defining a cavity, the housing including an outlet through which fluid can pass, the outlet being in communication with the cavity;
a top removably coupled to the housing, one of the housing and the top including an inlet through which fluid can pass, the inlet being in communication with the cavity, the housing defining a flow path between the inlet and the outlet; and
a drapeable pouch containing a filter media therein, the drapeable pouch being disposable in the cavity, the top engaging the drapeable pouch when the top is coupled to the housing, wherein one of the top and the housing bottom surface applies a force to the drapeable pouch so that the drapeable pouch and the filter media extend across the cavity and seal the flow path so that fluid entering the inlet engages the filter media in the drapeable pouch before the fluid exits the outlet of the housing.

13. The fluid filter of claim 12, wherein the housing wall extends around an inner perimeter of the cavity, and the drapeable pouch engages the housing wall around the inner perimeter of the cavity.

14. The fluid filter of claim 12, wherein the top includes an engagement portion coupled to a biasing member that biases the engagement portion into contact with the drapeable pouch.

15. The fluid filter of claim 12, wherein the housing includes an inner bottom surface and a spacing structure extending upwardly from the inner bottom surface, and the spacing structure engages the drapeable pouch and prevents the drapeable pouch from blocking the outlet when the drapeable pouch is in the housing.

16. The fluid filter of claim 12, wherein the housing has an upper end and a lower end opposite the upper end, the housing wall is tapered from the upper end to the lower end, the cavity has a first inner diameter proximate to the upper end and a second inner diameter proximate to the lower end, and the first inner diameter is larger than the second inner diameter.

17. A fluid dispensing apparatus comprising:
a container defining a first area in which an unfiltered fluid to be filtered is located and a second area in which a filtered fluid is collected, the second area being spaced apart from the first area;
a filter coupleable to the container at a location between the first area and the second area, the filter receiving unfiltered fluid from the first area and removing at least one contaminant therefrom, the filter comprising:
a housing including a wall with an inner surface that defines a cavity, an inlet in communication with the cavity, and an outlet in communication with the cavity; and
a pouch being formed of a drapeable material defining a receptacle in which a filter media is located, the filter media being hydrated prior to the pouch being inserted into the housing, and when the pouch is inserted, the pouch extends across the housing cavity to ensure that fluid passing from the inlet to the outlet engages the filter media in the pouch before passing through the outlet.

18. The fluid dispensing apparatus of claim 17, wherein the pouch can be removed from the housing while the housing remains coupled to the container.

19. The fluid dispensing apparatus of claim 17, wherein the housing includes a first coupling mechanism, and the fluid dispensing apparatus further comprises:
a top removably coupled to the housing, the top including a second coupling mechanism engageable with the first coupling mechanism to secure the top to the housing.

20. The fluid dispensing apparatus of claim 19, wherein the top engages the pouch to apply a force to cause the pouch to extend laterally to continually engage the inner surface of the housing wall around a perimeter of the cavity.
